(19) United States
(12) Patent Application Publication
(10) Pub. No.: US 2026/0249377 A1
(43) Pub. Date: Aug. 27, 2026

(54) Portable Purge Chamber for Controlled Atmosphere Welding of Readily Contaminated Metals Like Titanium or Zirconium

(71) Applicant: Travis Field, Cypress, TX (US)

(72) Inventor: Travis Field, Cypress, TX (US)

(21) Appl. No.: 19/286,882

(22) Filed: Jul. 31, 2025

Related U.S. Application Data
(63) Continuation-in-part of application No. 19/065,178, filed on Feb. 27, 2025, now Pat. No. 12,420,351.
(62) Division of application No. 29/991,190, filed on Feb. 27, 2025.
Application No. 19/065,178 is a division of application No. 29/991,190, filed on Feb. 27, 2025.

(51) Int. Cl. B23K 9/32; B23K 101/04; B23K 103/08

(52) U.S. Cl. CPC B23K 9/326; B23K 2101/04; B23K 2103/08

(57) ABSTRACT

Disclosed is a modular purge chamber system designed to create precision-controlled inert or reactive gas environments for welding titanium, zirconium, aluminum, and other oxidation-prone metals. The system preferably addresses persistent challenges in maintaining atmospheric isolation during welding operations while improving accessibility and gas efficiency compared to traditional trailing shields.

### CROSS-REFERENCE TO RELATED APPLICATIONS

See Application Data Sheet (ADS).

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

An experimental prototype of the disclosed purge chamber system was tested by the inventor, Travis Field, at the Kentucky Welding Institute on Feb. 10, 2025. During this evaluation, welding trainees and institute staff observed the system's structural configuration, including its concentric reducers, argon distribution hoses, stainless steel wool diffusers, and recessed latch mechanism. The demonstration involved welding titanium and zirconium piping under controlled inert conditions, achieving oxygen levels below 25 ppm and oxidation-free welds in 83% of novice attempts.

### Background of the Invention

### Field of Invention

This specification describes subject matter in the field of welding technology, specifically to systems and methods for shielding reactive metals such as titanium, zirconium, and aluminum during welding processes. More particularly, it pertains to portable, modular gas purge systems designed to isolate weld joints from atmospheric contamination while optimizing gas efficiency and operational accessibility.

### Background of the Invention

The field of welding reactive metals such as titanium and zirconium has long faced a critical challenge: maintaining an oxygen-free environment during the welding process.

These metals, valued for their exceptional strength-to-weight ratios and corrosion resistance, rapidly form brittle oxides and nitrides when exposed to atmospheric gases at the elevated temperatures inherent to welding.

For instance, commercially pure titanium typically comprises at least 99% titanium, with strict impurity limits that are easily exceeded during conventional welding processes.

Key impurity thresholds include iron (≤0.30%), carbon (≤0.08%), nitrogen (≤0.03%), oxygen (≤0.25%), and hydrogen (≤0.015%), with total other elements capped at 0.40%. Even trace oxygen levels exceeding 25 parts per million (ppm) during welding can degrade weld integrity, leading to embrittlement, discoloration, and reduced fatigue life-compromising the metal's structural and chemical properties.

Traditional shielding methods, such as trailing shields or inert gas curtains, have proven insufficient due to their reliance on operator skill to maintain dynamic gas coverage, geometric inflexibility, and excessive gas waste. Partial shielding from trailing systems often allows atmospheric infiltration through minor gaps, leading to oxygen, nitrogen, or hydrogen contamination-particularly detrimental in aerospace, nuclear, and medical applications where weld purity is non-negotiable. Complex joint geometries exacerbate these issues, as turbulent gas flow in conventional systems wastes inert gas (40-60 cubic feet per hour, CFH) while failing to ensure consistent coverage.

Prior art systems, such as Brandt's stationary gas shielding apparatus (U.S. Pat. No. 4,562,334), utilize screen-walled chambers to direct inert gas over weld areas. While effective for fixed applications, Brandt's design lacks adaptability to variable pipe diameters and induces turbulence at high flow rates, leaving weld zones vulnerable during torch repositioning.

Stol's dual-chamber system (U.S. Pat. No. 4,528,436), though innovative for nuclear piping, requires precise alignment with rotating workpieces and offers no modularity for field repairs. Widely adopted trailing shields, such as Huntingdon Fusion's Argweld® models, demand constant manual pressure to maintain inert coverage—a skill-intensive process prone to failure on thin-walled or geometrically complex joints.

These conventional methods share critical deficiencies. Dynamic trailing shields expose heat-affected zones (HAZ) to contamination during cooling phases, while static systems consume excessive inert gas through turbulent flow. Furthermore, existing solutions lack compatibility with hybrid gas workflows, such as integrating reactive gases like carbon tetrachloride (CCl₄) for in-situ oxide removal as taught by Jordan's foundational work (U.S. Pat. No. 2,576,793). The industry's reliance on rigid, operator-dependent systems has resulted in inconsistent weld quality, high rework costs, and limited accessibility for novice welders.

The present invention addresses these gaps through a portable, modular purge chamber that encapsulates weld joints in a fully inert atmosphere. By replacing partial shielding with static encapsulation and integrating turbulence-reducing diffusers, the system achieves uniform argon coverage at 25-35 feet per hour (CFH)—less than half the consumption of trailing shields. Its split-shell design, featuring concentric reducers and silicone seals, adapts to +10% pipe diameter variance, enabling field deployment without custom machining. Crucially, the chamber supports hybrid inert/reactive gas workflows, bridging mid-20th-century metallurgical principles with modern manufacturing demands.

In essence, prior art systems fail to reconcile portability, gas efficiency, and operator accessibility. The invention resolves this by democratizing skill requirements and ensuring contamination-free welds across industries, offering a paradigm shift in reactive metal welding through full encapsulation, optimized gas dynamics, and adaptive sealing technologies.

The embodiment of FIGS. 1-25 describes a single monolithic split-shell configuration, sized for ±10% diameter variance, but offers no on-the-fly reconfiguration for different materials or shapes. Modular high-temp adaptability utilizing hot-swap modules fabricated from refractory ceramics, high-performance thermoplastics (PEI, PPS, PEEK), or fiber-reinforced composites provide robust, load-bearing support and thermal resilience.

A solution to these limitations involves introducing a much broader palette of materials-ranging from refractory ceramics and high-performance thermoplastics (PEI, PPS, PEEK) to fiber-reinforced composites and even fully metallic bodies such as 316L stainless steel and Inconel 625—that can withstand continuous service above 500° C. without loss of performance.

### SUMMARY OF THE INVENTION

The purge chamber of FIGS. 1-25 was engineered to clamp around straight-pipe sections only. When welds needed to be performed on elbows, tees, flanges, saddle joints, inside diameter of vessels or other non-linear fittings, the current design of the purge chamber would not accommodate.

By leveraging its modular, high-temperature architecture and a wide range of advanced materials, the purge chamber (2000) transcends its original scope to serve as an indispensable tool wherever absolute inert-gas protection is required. From aerospace and nuclear energy to chemical processing, semiconductors, and advanced manufacturing, its field-swappable modules, inflatable sealing variants, and hybrid rigid-elastomer assemblies ensure a consistently pure atmosphere around reactive alloys-whether welding titanium, zirconium, aluminum, or other corrosion-sensitive metals-preserving metallurgical integrity and weld quality under the most demanding conditions.

This specification introduces a modular purge chamber system designed to create precision-controlled inert or reactive gas environments for welding titanium, zirconium, aluminum, and other oxidation-prone metals. The system preferably addresses persistent challenges in maintaining atmospheric isolation during welding operations while improving accessibility and gas efficiency compared to traditional trailing shields. The purge chamber further solves the problem of maintaining a stable, oxygen-free environment when welding reactive metals such as titanium and zirconium where, without proper purging, these metals are highly susceptible to contamination from atmospheric gases like oxygen, nitrogen, and hydrogen, which can cause weld discoloration, oxidation, embrittlement, and reduced mechanical properties.

In one embodiment, the purge chamber system comprises split-shell concentric reducers constructed from heat-resistant polymers or PVC, which clamp around weld joints via a recessed latch system to form a sealed enclosure. A gas distribution network, employing eight ¼″ hoses, delivers argon through stainless steel wool and 200-mesh diffusers to achieve laminar flow at 25-35 cubic feet per hour (CFH), minimizing turbulence and oxygen levels below 25 parts per million (ppm). Adaptive sealing mechanisms-including high-temperature silicone padding and heat-resistant tape-ensure airtight isolation of the weld zone while permitting quadrant-based access for welding. Transparent viewing windows, optionally supplemented by internal LED lighting, enable real-time inspection without disrupting the inert environment. For LED lighting, the lights may be incorporated into the body of the concentric reducer, for example, around the rim on the inside of the hood and an external power source, for example, battery power source.

By combining modular encapsulation, hybrid gas compatibility, and turbulence-reducing diffusers, the invention democratizes welding proficiency while ensuring contamination-free results across high-value industries.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1 is a front perspective view of a purge chamber (2000) installed on a workpiece (3000);

FIG. 2 is a front perspective view of another configuration of the purge chamber (2000) installed on a workpiece (3000)

FIG. 3 is top perspective view of the a split shell (1000) of a purge chamber (2000) installed on a workpiece (3000);

FIG. 4 is a side perspective view of the a split shell (1000) of a purge chamber (2000) installed on a workpiece (3000);

FIG. 5 is a side perspective view of the an alternative configuration of a split shell (1000) of a purge chamber (2000) installed on a workpiece (3000);

FIG. 6 is another side perspective view of the split shell (1000) of a purge chamber (2000) installed on a workpiece (3000);

FIG. 7 is top view of the split shell (1000) of a purge chamber (2000) installed on a workpiece (3000);

FIG. 8 is a bottom view of the split shell (1000) of a purge chamber (2000) installed on a workpiece (3000);

FIG. 9 is a side view of the split shell (1000) of a purge chamber (2000) installed on a workpiece (3000);

FIG. 10 is an opposite side view of the split shell (1000) of a purge chamber (2000) installed on a workpiece (3000);

FIG. 11 is a front view of the split shell (1000) of a purge chamber (2000) installed on a workpiece (3000);

FIG. 12 is a rear view of the split shell (1000) of a purge chamber (2000) installed on a workpiece (3000);

FIG. 13 is an exploded perspective view of the split shell (1000) of a purge chamber (2000) and workpiece (3000);

FIG. 14 an exploded side view of the split shell (1000) of a purge chamber (2000) and workpiece (3000);

FIG. 15 is an outer perspective view of half of the split shell (1000);

FIG. 16 is an inner perspective view of half of the split shell (1000);

FIG. 17 is another perspective view of half of the split shell (1000);

FIG. 18 is a top view of half of the split shell (1000);

FIG. 19 is an inside view of half of the split shell (1000);

FIG. 20 is an exploded perspective view of half a work piece (1000) and half of the split shell (1000) side view of the one side of a purge chamber (2000) constructed of two sides of purge chamber devices (1000);

FIG. 21 is another exploded perspective view of half a work piece (1000) and half of the split shell (1000) side view of the one side of a purge chamber (2000) constructed of two sides of purge chamber devices (1000);

FIG. 22 is an exploded perspective view of half a work piece (1000) installed in half of the split shell (1000) side view of the one side of a purge chamber (2000) constructed of two sides of purge chamber devices (1000);

FIG. 23 is a perspective view of a purge chamber (2000) constructed of two split cells (1000) installed on a workpiece (3000);

FIG. 24 is another perspective view of a purge chamber (2000) constructed of two split cells (1000) installed on a workpiece (3000);

FIG. 25 is an exploded view of a purge chamber (2000) constructed of two split cells (1000) installed on a workpiece (3000) and heat resistant tape (1300) with a window (1310);

FIG. 25A is a perspective view of an alternate embodiment of the purge chamber (2000) where the latch system (1110) of FIG. 25 is replaced with a metallic hose clamp;

FIG. 26A is a bottom view of a purge chamber for a 45 degree elbow;

FIG. 26B is a right side view thereof the purge chamber for a 45 degree elbow;

FIG. 26C is a left side view thereof the purge chamber for a 45 degree elbow;

FIG. 26D is a front view thereof the purge chamber for a 45 degree elbow;

FIG. 26E is a top view thereof the purge chamber for a 45 degree elbow;

FIG. 26F is a demonstrative view showing a 45 degree elbow being installed within the purge chamber for the 45 degree elbow;

FIG. 27A is a rear view of a purge chamber for a 90 degree elbow;

FIG. 27B is a right side view thereof the purge chamber for a 90 degree elbow;

FIG. 27C is a left side view thereof the purge chamber for a 90 degree elbow;

FIG. 27D is a front view thereof the purge chamber for a 90 degree elbow;

FIG. 27E is a bottom view thereof the purge chamber for a 90 degree elbow;

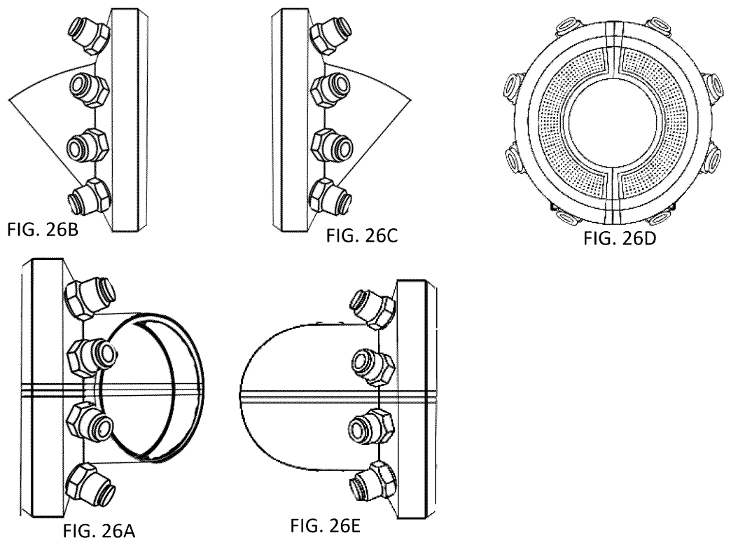

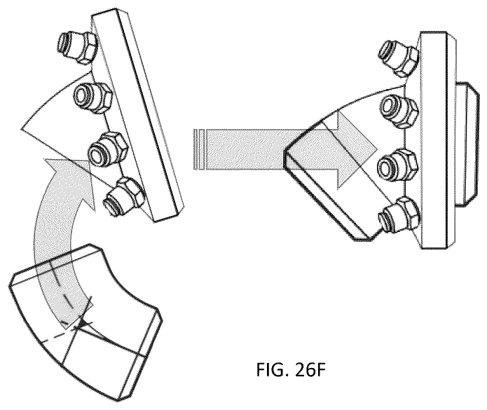

FIG. 26F is a top view thereof the purge chamber for a 90 degree elbow;

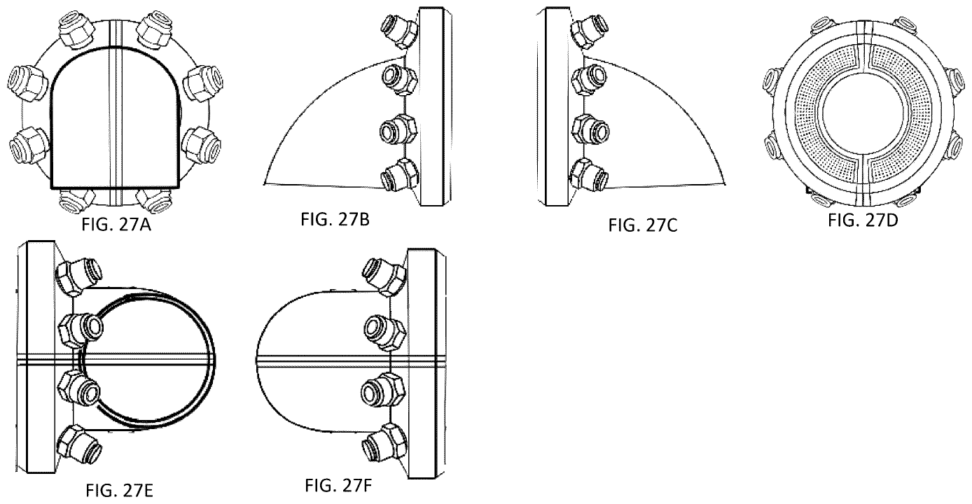

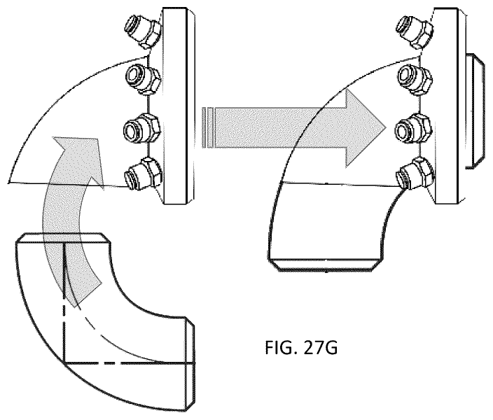

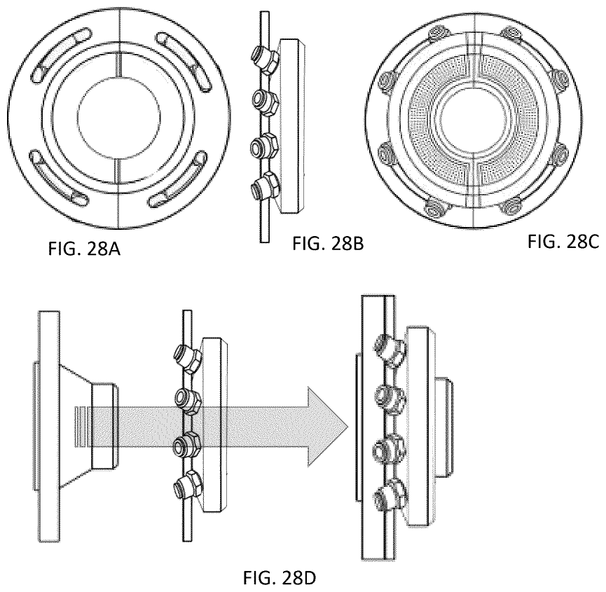

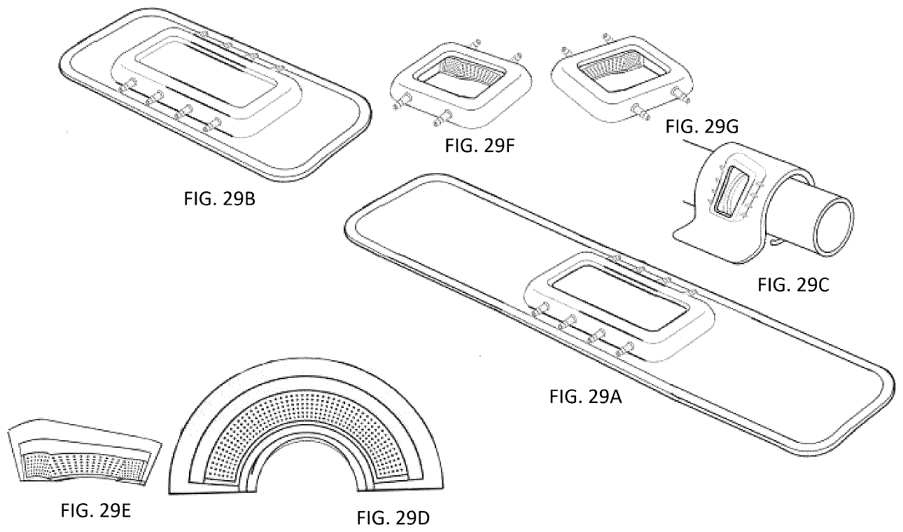

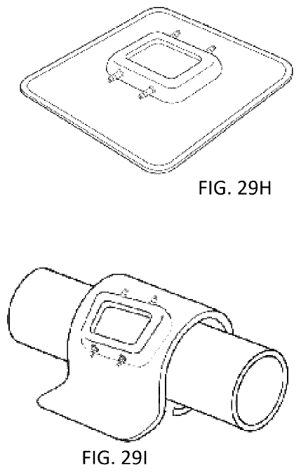

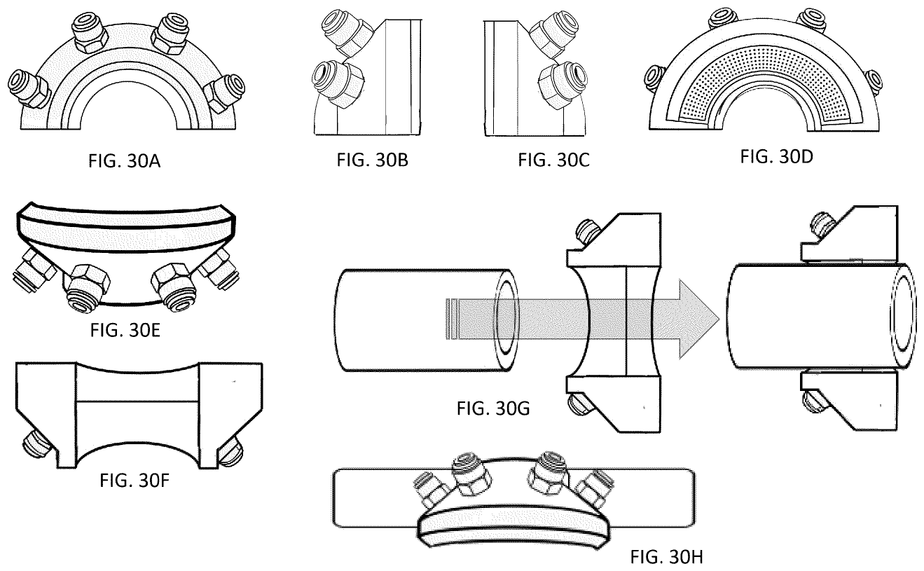

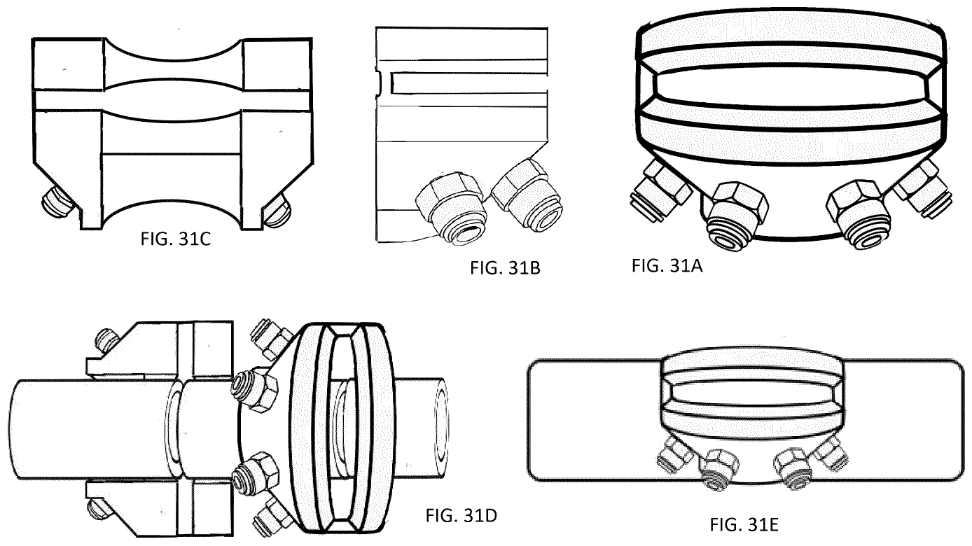

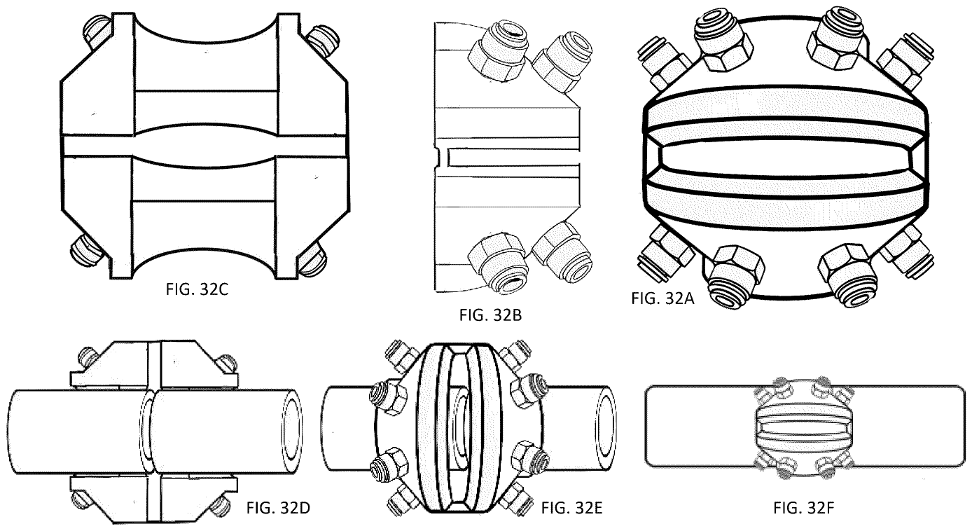

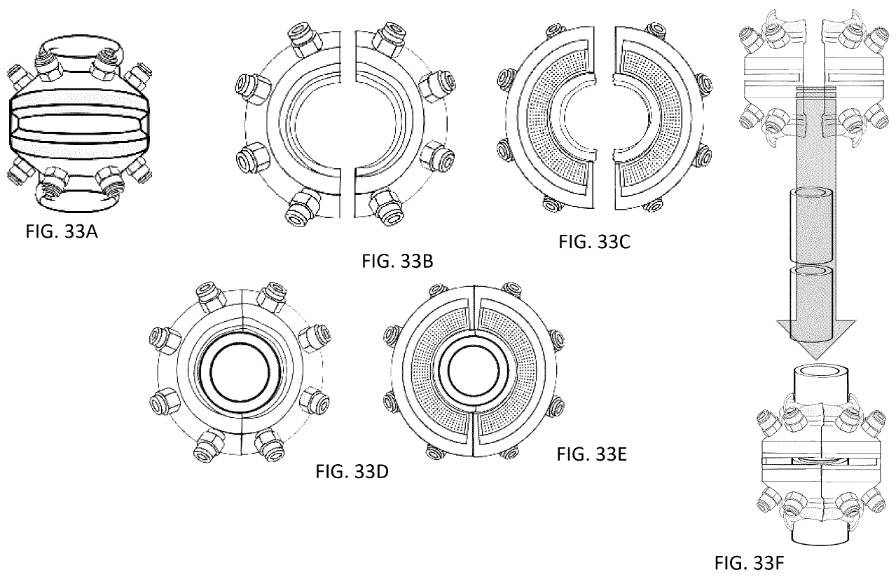

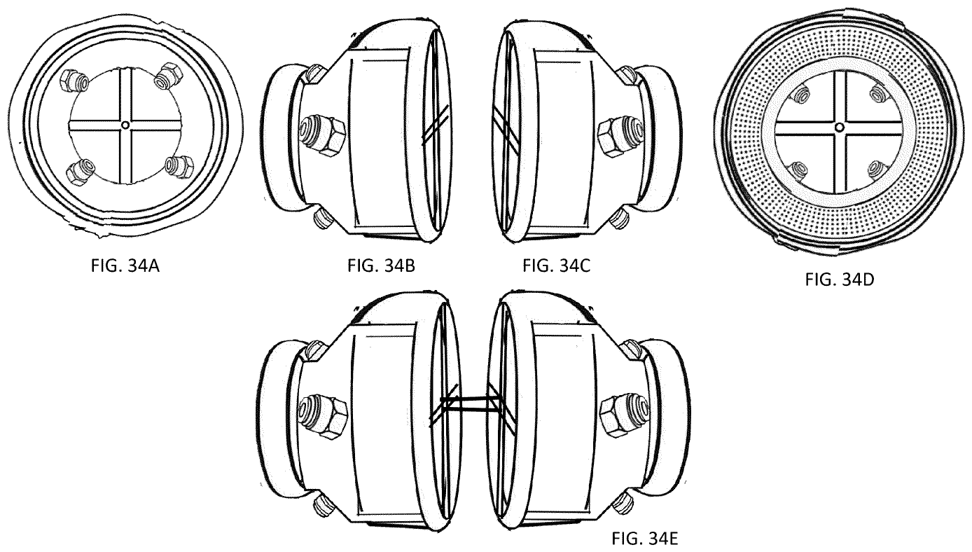

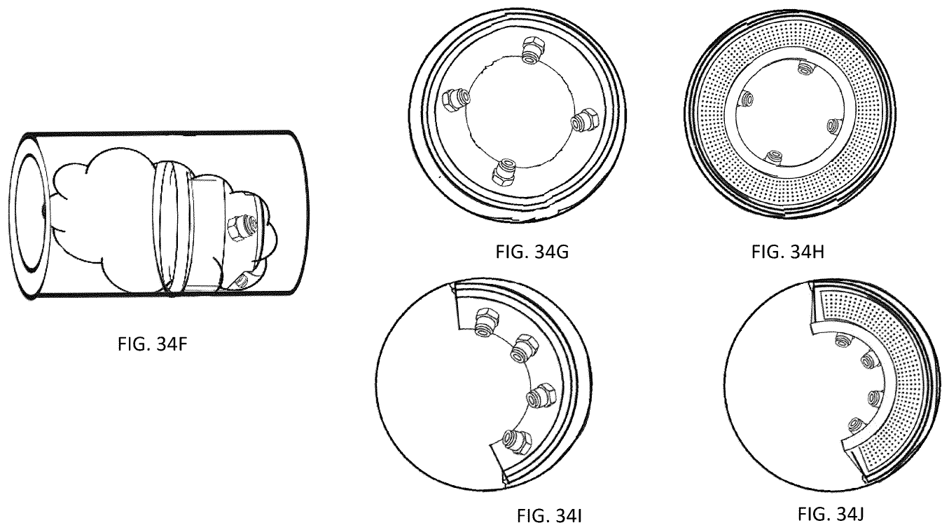

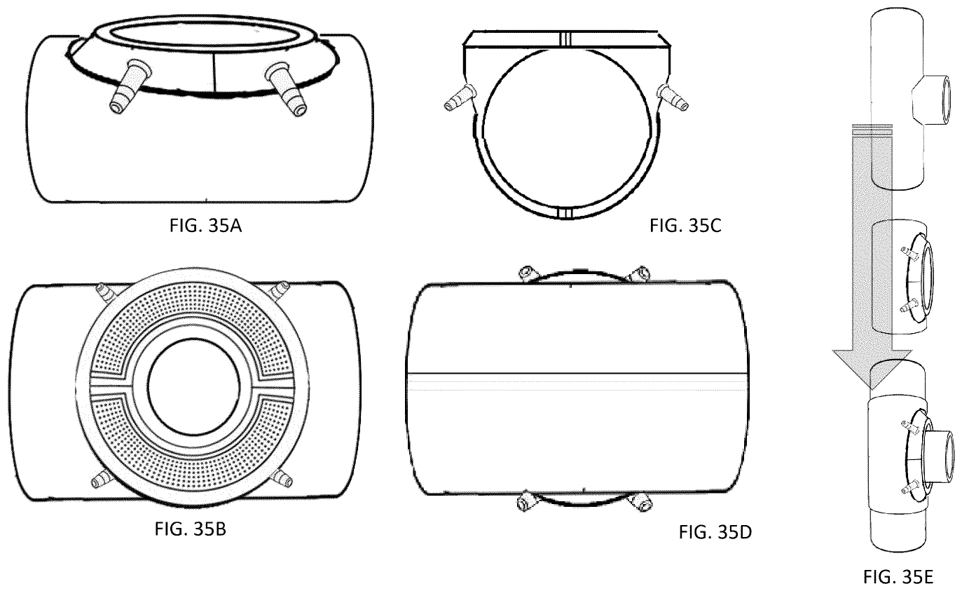

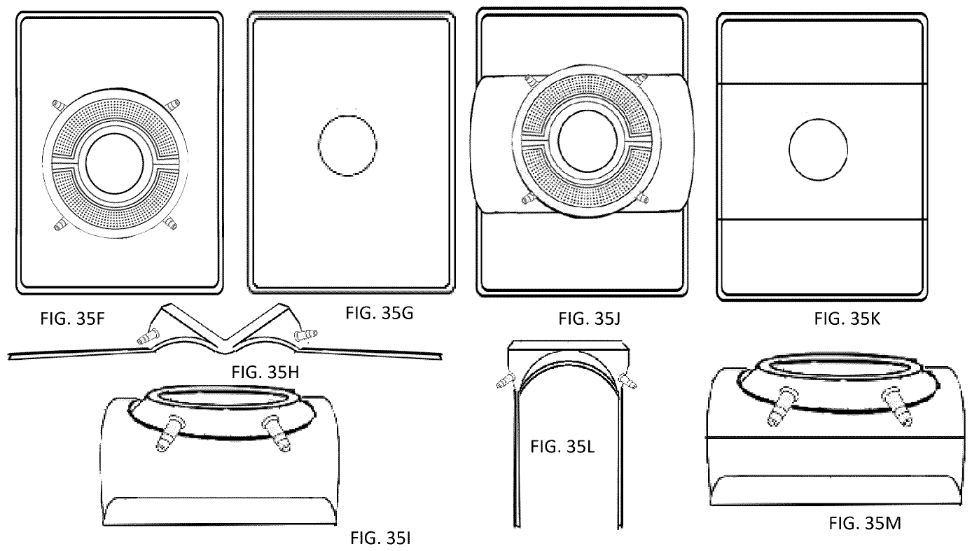

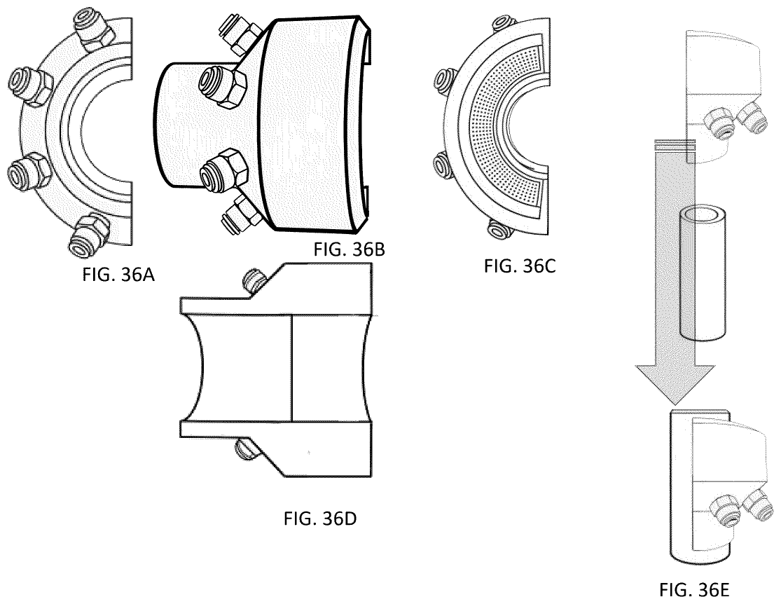

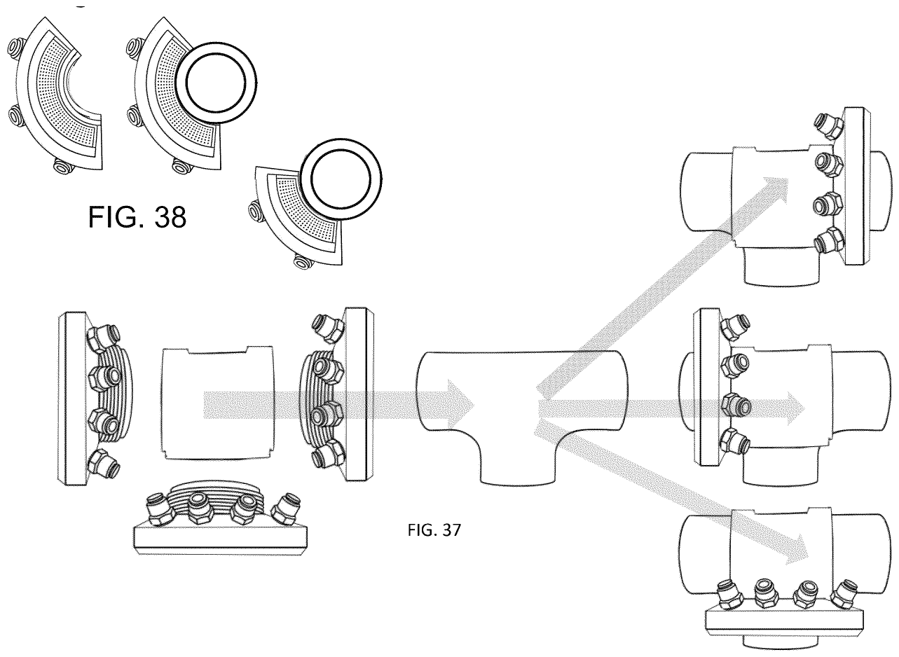

FIG. 27F is a demonstrative view showing a 90 degree elbow being installed within the purge chamber for the 90 degree elbow;

FIG. 28A is a rear view of a purge chamber for a flange;

FIG. 28B is a right side view thereof the purge chamber for flange;

FIG. 28C is a left side view thereof the purge chamber for a flange;

FIG. 28D is a demonstrative view showing a flange being installed within the purge chamber for the flange;

FIG. 29A is a perspective view of a wrap around purge chamber with silicon wrapper;

FIG. 29B is another perspective view of a wrap around purge chamber with silicon wrapper;

FIG. 29C is a demonstrative view showing the wrap around purge chamber with a silicon wrapper wrapped around a work piece;

FIG. 29D is an example of a purge chamber vent that bends around a work piece when installed.

FIG. 29E is another example of a purge chamber vent that bends around a workpiece;

FIG. 29F is a purge chamber vent for a silicon wrapper;

FIG. 29G is another perspective view of a purge chamber vent for a silicon wrapper;

FIG. 29H is a perspective view of a wrap-around purge chamber with silicon wrapper;

FIG. 29I is a demonstrative view showing a flange being installed within the purge chamber for the flange;

FIG. 30A is a rear view of a miniature purge chamber for smaller workpieces;

FIG. 30B is a right side view thereof the miniature purge chamber for smaller workpieces;

FIG. 30C is a left side view thereof the miniature purge chamber for smaller workpieces;

FIG. 30D is a front view thereof the miniature purge chamber for smaller workpieces;

FIG. 30E is a top view thereof the miniature purge chamber for smaller workpieces;

FIG. 30F is a bottom view thereof the miniature purge chamber for smaller workpieces;

FIG. 30G is a demonstrative view showing a smaller workpiece being installed within the miniature purge chamber;

FIG. 30H is a top view thereof the miniature purge chamber for smaller workpieces where the purge chamber has a silicone strap for securing the purge chamber to the smaller work pieces;

FIG. 31A is top view of an alternative embodiment of the miniature purge chamber for smaller workpieces, where an additional rim is provided so that a work area is established between the purge chamber and the additional rim;

FIG. 31B is a left side view thereof the alternative miniature purge chamber for smaller workpieces;

FIG. 31C is a bottom view thereof the alternative miniature purge chamber for smaller workpieces;

FIG. 31D is a demonstrative view thereof the alternative miniature purge chamber for smaller workpieces being installed on a smaller workpiece;

FIG. 31E is a top view of the miniature purge chamber for smaller workpieces where the alternative chamber includes a silicone strap for securing the same to smaller workpieces;

FIG. 32A is top view of an alternative embodiment of the miniature purge chamber for smaller workpieces, where an additional rim is provided so that a work area is established between the purge chamber and the additional rim;

FIG. 32B is a left side view thereof the alternative miniature purge chamber for smaller workpieces;

FIG. 32C is a bottom view thereof the alternative miniature purge chamber for smaller workpieces;

FIG. 31D is a demonstrative view thereof the alternative miniature purge chamber for smaller workpieces being installed on a smaller workpiece;

FIG. 31E is a demonstrative view thereof the alternative miniature purge chamber for smaller workpieces being installed on a smaller workpiece;

FIG. 31F is a top view of the miniature purge chamber for smaller workpieces where the alternative chamber includes a silicone strap for securing the same to smaller workpieces;

FIG. 33A is a top view of a purge chamber with an inflatable bladder for externally securing the workpiece within the chamber;

FIG. 33B is a rear view of the chamber with the bladder deflated;

FIG. 33C is a front view of the chamber with the bladder deflated;

FIG. 33D is a rear view of the chamber with the bladder inflated so that the chamber may be closed around a workpiece;

FIG. 33E is a front view of the chamber with the bladder inflated so that the chamber may be closed around the workpiece;

FIG. 33F is a demonstrative view thereof the inflatable purge chamber being installed on a

FIG. 34A is a rear view of a purge chamber with an inflatable bladder for internally securing the chamber within a workpiece;

FIG. 34B is a right side view of a purge chamber with an inflatable bladder for internally securing the chamber within a workpiece;

FIG. 34C is a left side view of a purge chamber with an inflatable bladder for internally securing the chamber within a workpiece;

FIG. 34D is a front view of a purge chamber with an inflatable bladder for internally securing the chamber within a workpiece;

FIG. 34E is a side view of two purge chamber chambers connected via a central connector where each chamber features an inflatable bladder for internally securing the chamber within a workpiece;

FIG. 34F is a perspective demonstrative view thereof the inflatable purge chamber being installed in a workpiece;

FIG. 34G is a rear demonstrative view thereof the inflatable purge chamber being installed in a workpiece;

FIG. 35H is a front demonstrative view thereof the inflatable purge chamber being installed in a workpiece;

FIG. 34I is a rear demonstrative view thereof an alternative embodiment of an inflatable purge chamber being installed in a workpiece;

FIG. 34J is a front demonstrative view thereof an alternative embodiment of an inflatable purge chamber being installed in a workpiece;

FIG. 35A is a side view of an OLET purge chamber sleeve for a workpiece;

FIG. 35B is a top view of an OLET purge chamber sleeve for a workpiece;

FIG. 35C is a front or rear view of an OLET purge chamber sleeve for a workpiece;

FIG. 35D is a bottom view of an OLET purge chamber sleeve for a workpiece;

FIG. 35E is a demonstrative view of an OLET purge chamber sleeve being installed on a workpiece;

FIG. 35F is a top view of an alternate OLET purge chamber wrap-around sleeve for a workpiece;

FIG. 35G is a bottom view of an alternate OLET purge chamber wrap-around sleeve for a workpiece;

FIG. 35H is a side view of an alternate OLET purge chamber wrap-around sleeve for a workpiece;

FIG. 35I is a side view of an alternate, wrapped OLET purge chamber wrap-around sleeve fir a workpiece;

FIG. 35J is a top view of an alternate OLET purge chamber wrap-around sleeve for a workpiece;

FIG. 35K is a bottom view of an alternate OLET purge chamber wrap-around sleeve for a workpiece;

FIG. 35L is a side view of an alternate OLET purge chamber wrap-around sleeve for a workpiece;

FIG. 35M is a side view of an alternate, wrapped OLET purge chamber wrap-around sleeve fir a workpiece;

FIG. 36A is a rear view of a self-contained purge chamber for a workpiece;

FIG. 36B is a top view thereof the self-contained purge chamber;

FIG. 36C is a front view thereof the self-contained purge chamber;

FIG. 36D is a bottom view thereof the self-contained purge chamber;

FIG. 36E is a demonstrative view of the self-contained purge chamber being installed on a

FIG. 37 is a demonstrative of a threaded purge chamber being installed in on hub around a t-shaped workpiece; and,

FIG. 38 illustrates custom arc-length segments where modular chamber segments can be custom-manufactured to cover specific arc lengths, such as 60°, 90°, 120°, 180°, or other specialized angles, providing flexible adaptation to diverse pipe and vessel geometries, with bodies that can be minimized in size and made of rigid material, elastomeric material, or combination of the two. In the figures, the following components of the preferred embodiment are shown in connection with the corresponding reference numeral identified below:
2000—Purge Chamber
1000—concentric reducers
1100—split shell
1101—receptacle
1102—hood
1103—guide-rim or lip
1110—latch system
1120—heat shield and/or gasket of high-heat silicone
1130—stainless steel wool diffuser
1140—fine stainless steel woven mesh diffuser
1150—stainless steel perforated sheet diffuser
1200—Gas Distribution Network
1210—hoses or tubing
1220—four-to-one hose or tubing adapter
1230—quick connect adapter (e.g., SharkBite® male adapter)
1300—heat-resistant tape
1310—window
3000—workpiece
3100—weld joint or point

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFFERED EMBODIMENTS

This is a specification of a modular purge chamber system designed to create precision-controlled inert or reactive gas environments for welding oxidation-prone workpieces. The disclosed purge chamber system preferably maintains atmospheric isolation of the weld point of a workpiece during welding operations. The system includes a gas distribution network aimed at improving accessibility and gas efficiency compared to traditional trailing shields. The more specific details of the disclosed purge chamber system are disclosed with reference to the FIGURES.

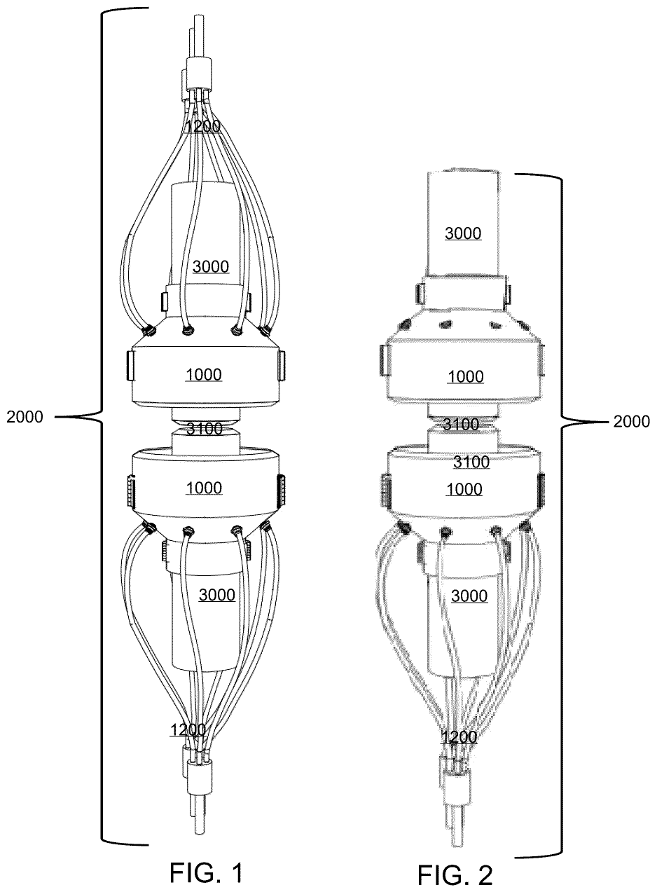

FIG. 1 illustrates a front perspective view of the purge chamber (2000) installed on a tubular workpiece (3000), showcasing a weld joint (3100). The chamber comprises two opposing split-shell assemblies (1000), each formed from concentric reducers. The reducers include a narrowed receptacle (1101) that clamps around the workpiece (3000) and an expanded hood (1102) encapsulating the weld joint (3100). A recessed latch system (1110) secures the split shells (1000), compressing high-temperature silicone gaskets (1120) against the workpiece surface to create a gas-tight seal.

The hood (1102) features an access gap along its guide rim (1103), permitting unrestricted torch access to the weld joint (3100) while maintaining inert gas containment. Each split shell (1000) integrates a gas distribution network (1200) comprising eight ¼″ hoses (1210) connected to a four-to-one manifold (1220). Argon flows through these hoses into layered diffusers-stainless steel wool (1130), fine woven mesh (1140), and perforated sheets (1150)—to achieve laminar flow within the hood (1102). This configuration minimizes turbulence, maintaining oxygen levels below 25 ppm. Opposing gas streams from both shells (1000) create balanced pressure, preventing air ingress during welding or cooling phases.

In the FIG. 1 embodiment, opposing gas flows from dual split-shell assemblies (1000) create balanced pressure within the purge chamber (2000), maintaining oxygen levels below 25 ppm. The concentric reducers (1101) clamp around the tubular workpiece (3000), encapsulating the weld joint (3100) within the hood (1102). Operators secure the chamber (2000) around pre-cleaned joints, initiate argon flow via the ¾″ main inlet (1210), and monitor oxygen levels until <25 ppm is achieved. This configuration maintains inert shielding during welding and post-cooling phases, preventing delayed atmospheric contamination. The design accommodates upright, horizontal, or oblique workpiece orientations through adaptive sealing via silicone gaskets (1120) and recessed latches (1110).

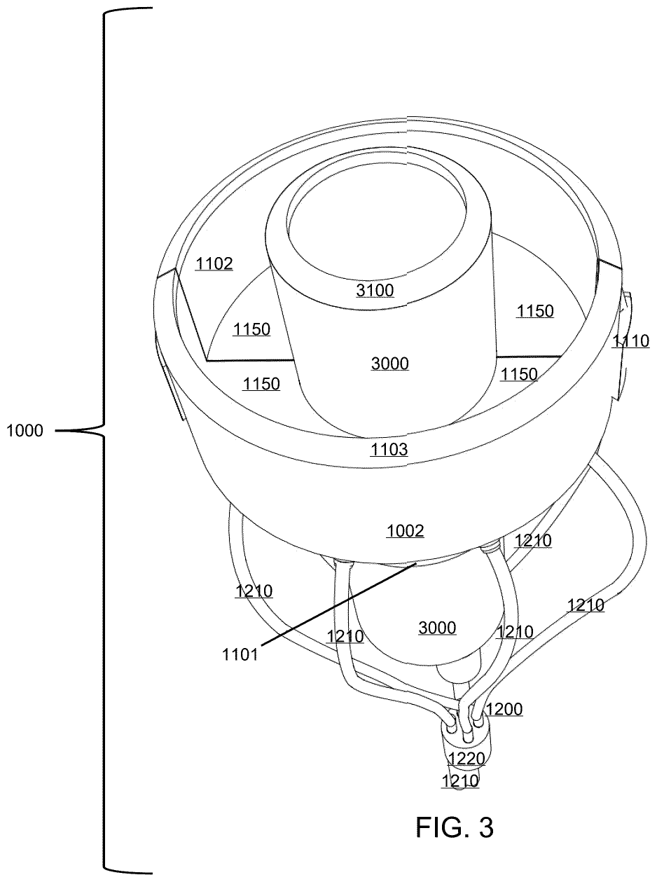

FIG. 2 illustrates an alternative purge chamber (2000) configuration where the upper split shell (1000) replaces the gas distribution network (1200) with vented ports (1230). This leverages argon's higher density relative to air to displace oxygen through gravity-assisted venting. Operators follow the same workflow as FIG. 1-securing the chamber, purging via the main inlet (1210), and maintaining <25 ppm O₂—but with reduced gas consumption in vertical orientations. The vented design retains full encapsulation during welding and cooling, preventing air ingress even in complex oblique alignments.

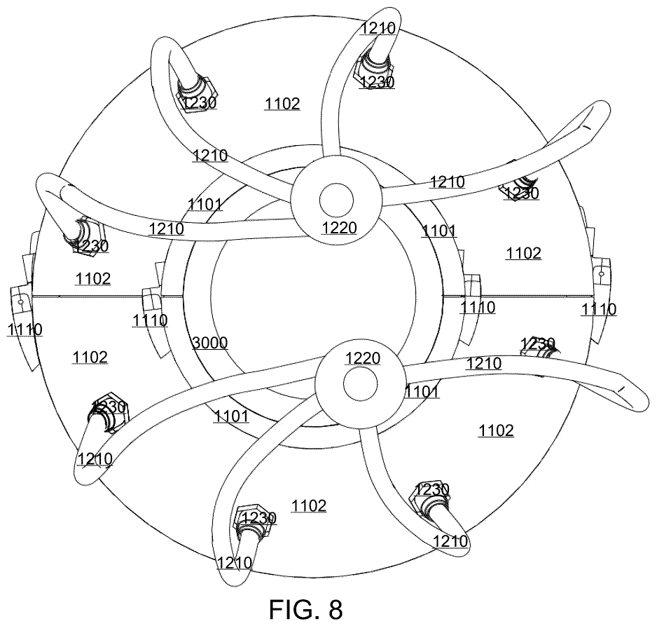

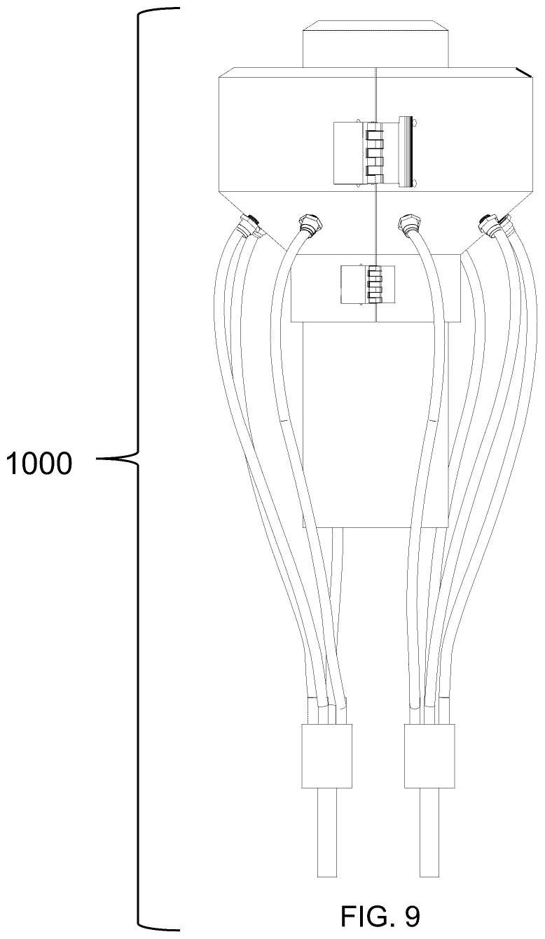

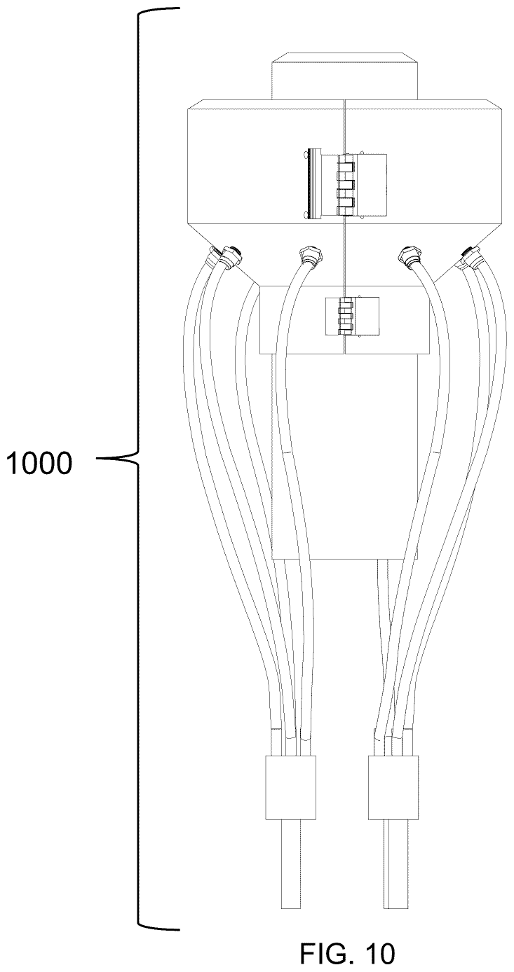

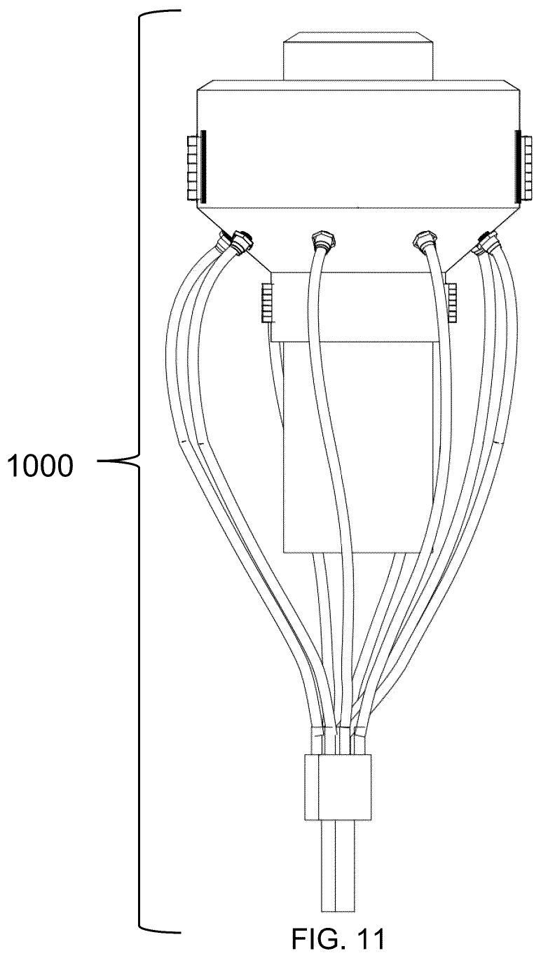

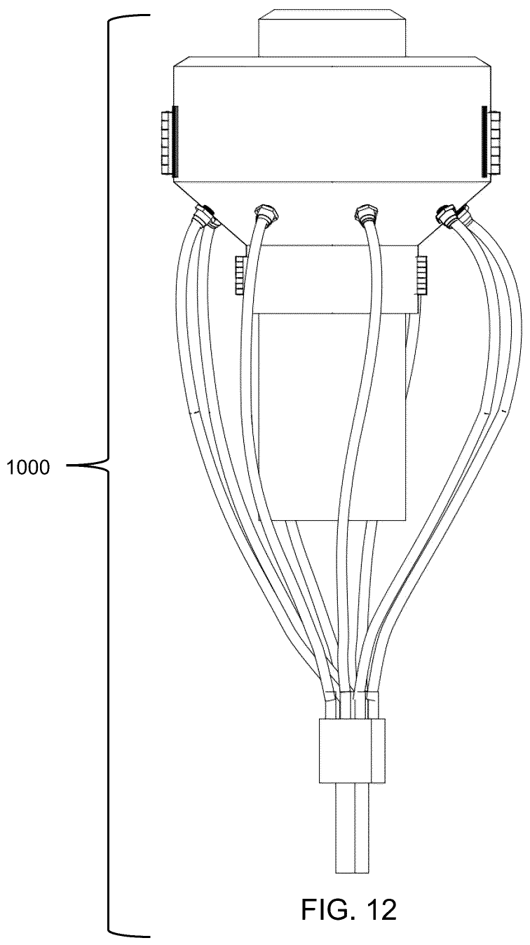

FIGS. 3-4 and 6-12 detail the split-shell assembly (1000) comprising heat-resistant polymer reducers (1101) clamped around the workpiece (3000). The recessed latch system (1110) compresses silicone gaskets (1120) against the workpiece's (3000) surface, forming an airtight seal at the receptacle (1101). Argon flows through eight ¼″ hoses (1210) connected to two four-to-one manifolds (1220), distributing gas radially through layered diffusers: stainless steel wool (1130), fine mesh (1140), and perforated plates (1150). These components eliminate turbulence, achieving laminar flow (<2,000 Reynolds number) across the weld joint (3100) within the hood (1102). The guide rim (1103) permits unrestricted TIG torch access while maintaining inert coverage.

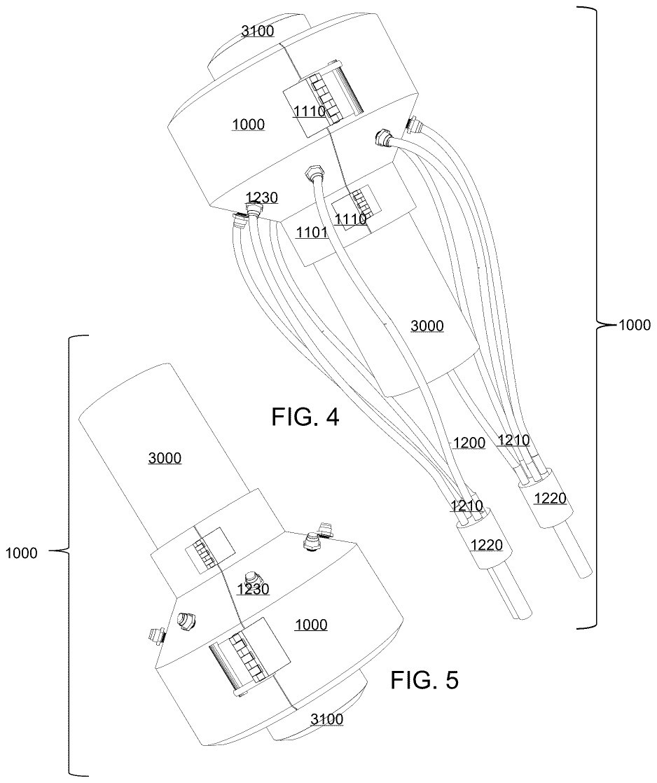

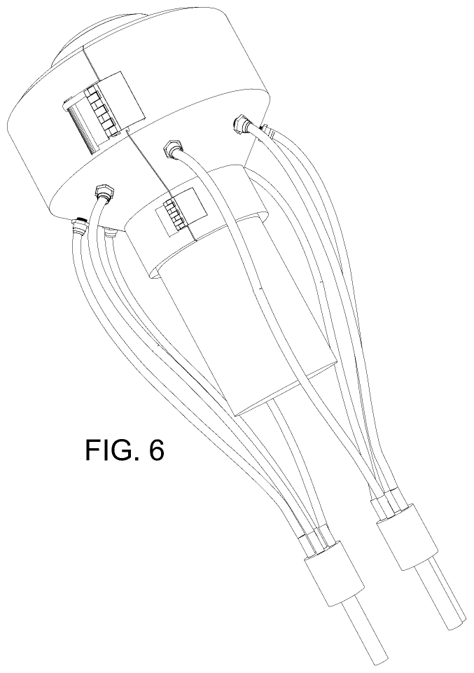

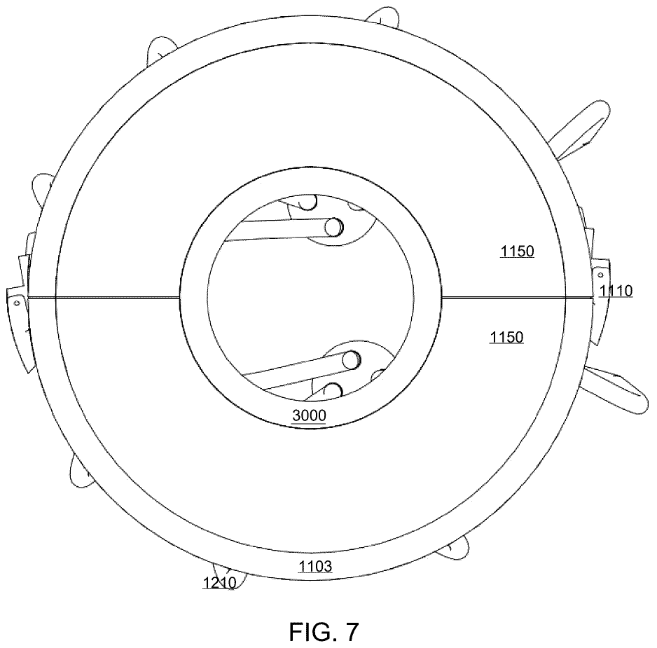

FIG. 5 depicts a vented split shell (1000) where gas distribution ports (1230) serve dual purposes: inert gas injection or pressure-regulated venting. This modularity allows the chamber (2000) to adapt to vertical welding applications by exploiting argon's density to passive ambient air. Quick-connect adapters (1230) enable rapid reconfiguration between active gas distribution (FIG. 1) and vented modes (FIG. 2), optimizing gas efficiency for varying workpiece orientations.

Key technical enhancements of the embodiments depicted in FIGS. 1 through 12 include: Gas Dynamics: Explicit linkage of diffuser layers (1130/1140/1150) to laminar flow metrics; Modularity: Clear differentiation between active gas injection (FIG. 1) and passive venting (FIGS. 2,5); Orientation Independence: Unified operational protocol for upright/horizontal/oblique configurations; Sealing Mechanism: Emphasis on silicone gasket (1120) compression via recessed latches (1110).

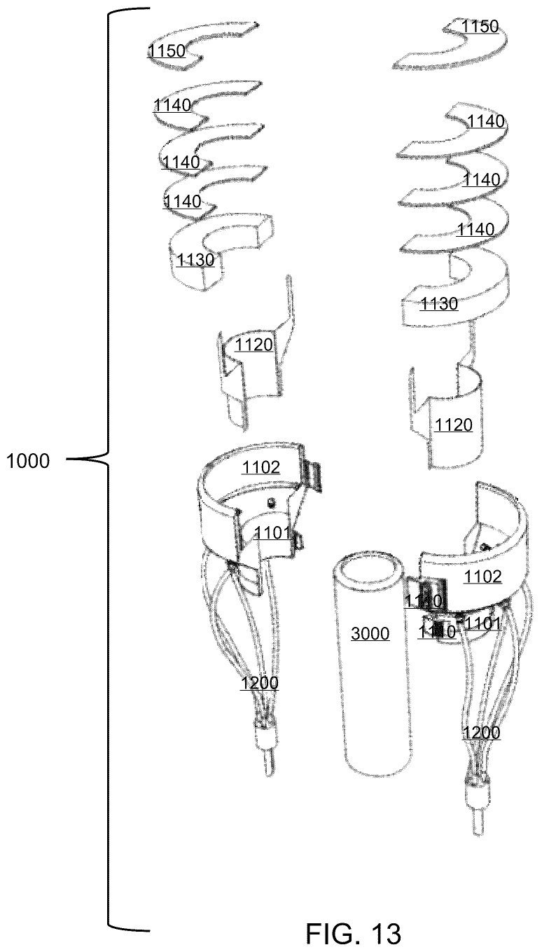

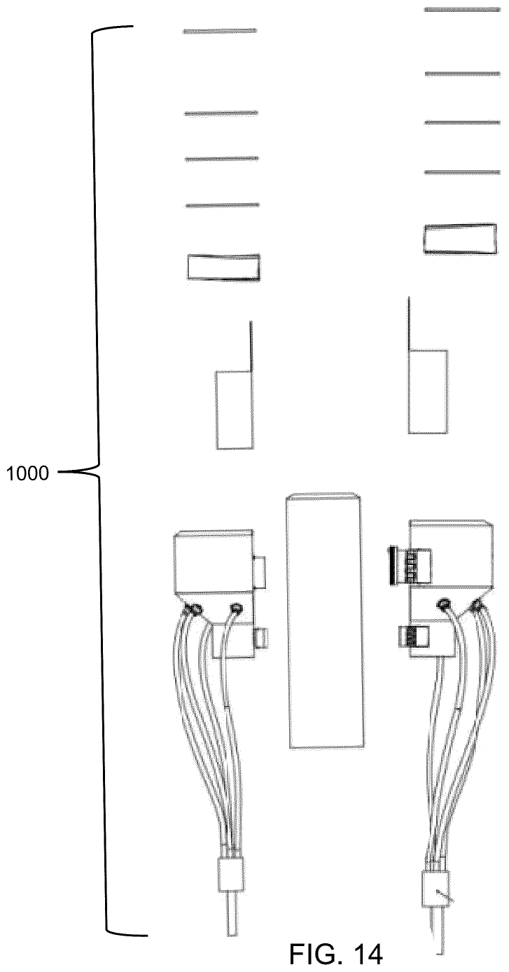

FIGS. 13 and 14 provide exploded perspective and side views of the split-shell assembly (1000) and workpiece (3000), detailing the purge chamber's (2000) modular construction. The assembly comprises two concentric reducers fabricated from split PVC or heat-resistant polymer shells, which clamp around the tubular workpiece (3000) via a receptacle (1101). A heat-resistant silicone gasket (1120) lines the inner circumference of the receptacle (1101) and the distal edges of each shell (1000), conforming to the workpiece surface to establish a gas-tight seal around the weld joint (3100).

Recessed latches (1110) on the hood (1102) and receptacle (1101) secure the shells (1000) during operation, compressing the silicone gasket (1120) to prevent air ingress. The hood (1102) integrates a gas distribution network (1200) featuring sequential diffuser layers: Stainless Steel Wool (1130): Positioned at the gas inlet to dissipate turbulence. Fine Woven Mesh (1140): Intermediate layer to homogenize flow distribution. Perforated Sheet (1150): Final layer to direct laminar argon streams across the weld joint (3100). These components collectively stabilize gas dynamics, maintaining oxygen levels below 25 ppm while optimizing argon utilization at 25-35 CFH. The exploded views emphasize the assembly's modularity, enabling rapid maintenance or reconfiguration for varying pipe diameters or reactive gas workflows.

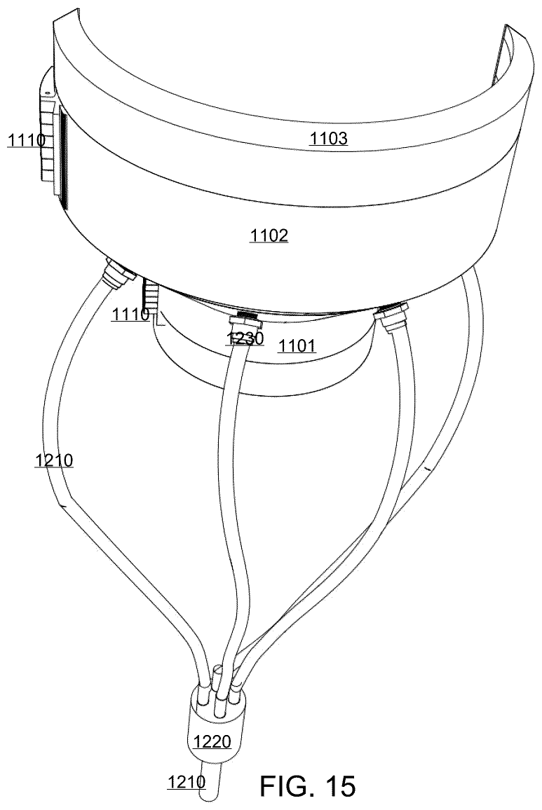

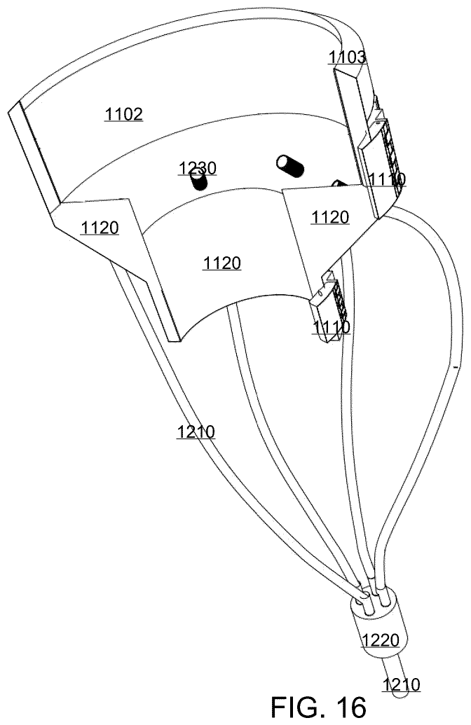

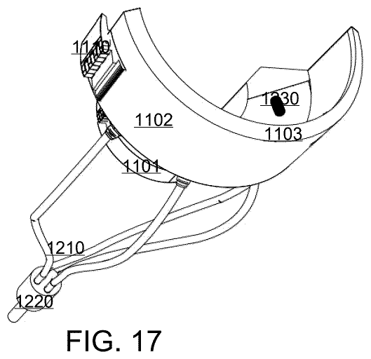

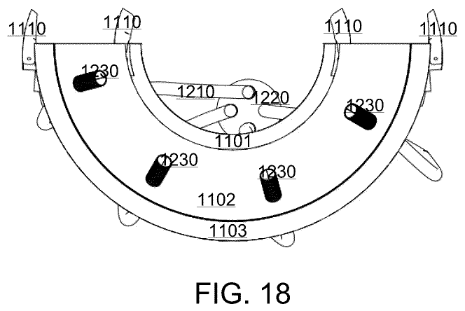

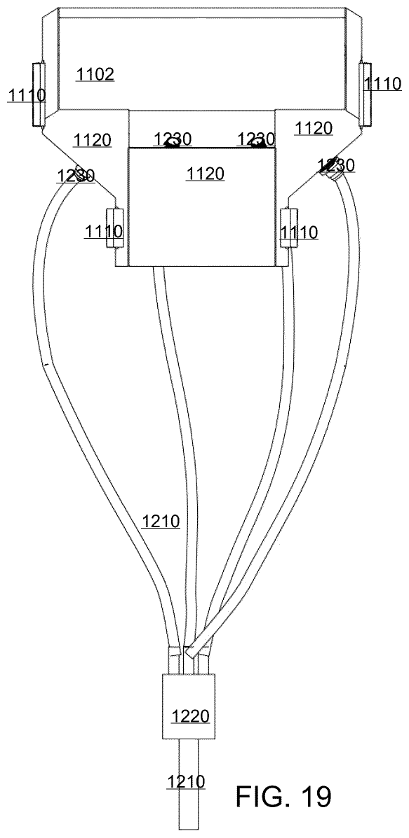

FIGS. 15 through 19 depict the split-shell (1000) and its integrated gas distribution network (1200). The half-shell (1000), formed from a heat-resistant polymer or PVC concentric reducer, comprises a hemispherical structure divided along its longitudinal axis. The larger diameter portion forms the hood (1102), while the reduced section defines the receptacle (1101), enabling the shell (1000) to clamp around tubular workpieces (3000) via opposing latches (1110). A beveled guide rim (1103) along the hood's (1102) edge facilitates precise torch positioning during welding operations, ensuring unrestricted access to the weld joint (3100) while maintaining inert gas containment. In some cases, a welding torch may be set against the rim (1103) during welding as a support or guide for the torch.

The receptacle (1101) incorporates a heat-resistant silicone gasket (1120) (FIG. 19) that conforms to the workpiece (3000) surface, creating an airtight seal adjacent to the weld joint (3100). Recessed latches (1110) on the hood (1102) and receptacle (1101) compress the gasket (1120) during closure, preventing atmospheric ingress while allowing rapid assembly and disassembly.

The gas distribution network (1200) within the hood (1102) includes four ¼″ hoses (1210) connected to a four-to-one manifold (1220). Argon flows from a single source hose (1210) through the manifold (1220) into the four hoses (1210), which terminate at quick-connect adapters (1230) mounted on the hood (1102). These adapters (1230) enable modular coupling to external gas lines or auxiliary reactive gas injectors, ensuring laminar gas flow across the weld zone.

In prototype configurations, the split-shell (1000) mimics a standard pipe reducer fitting, with the hood (1102) and receptacle (1101) proportioned to accommodate pipe diameter variances up to ±10%. This design ensures compatibility with conventional piping systems while providing a guided, contamination-free environment for welding reactive metals.

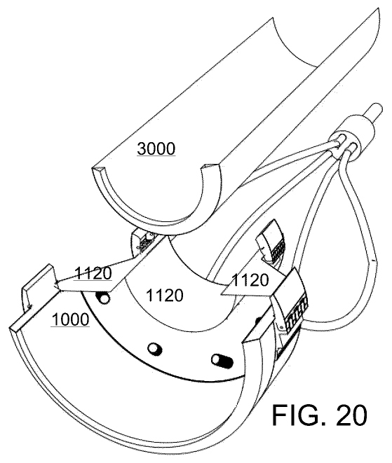

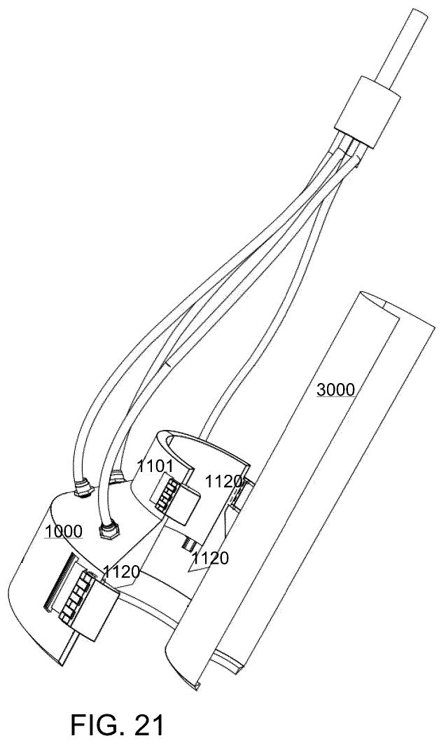

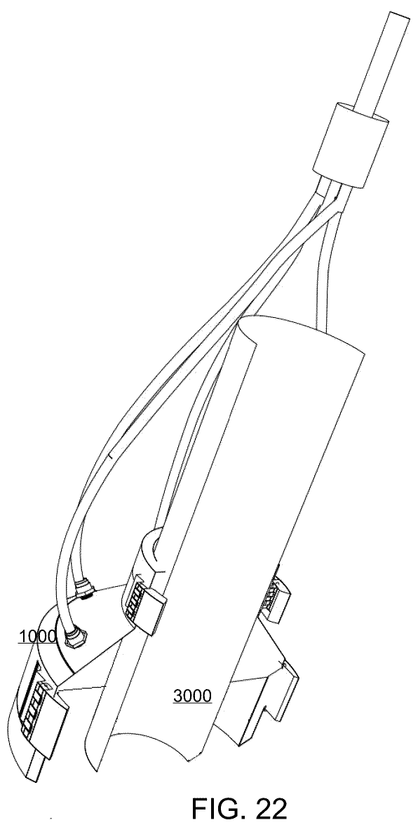

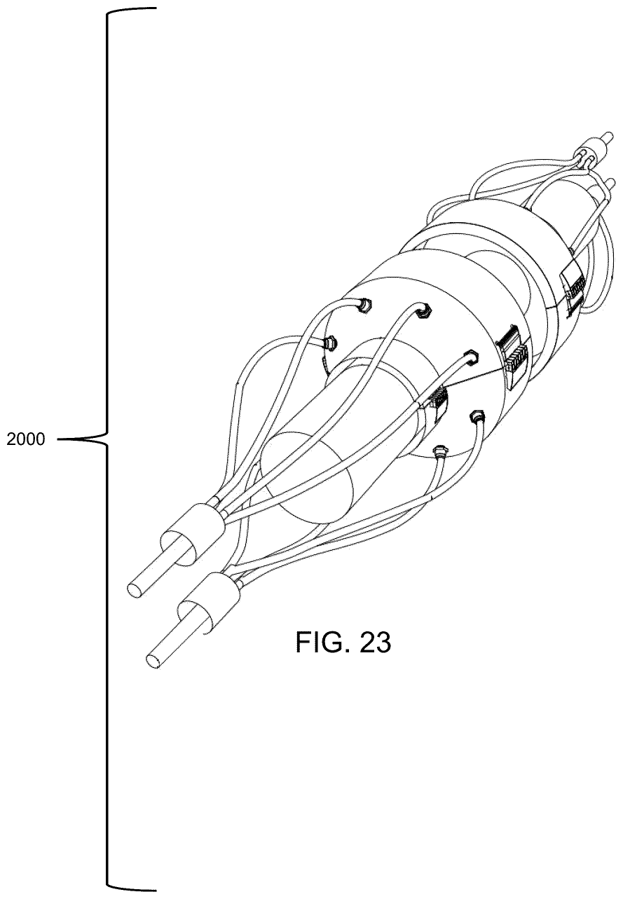

The recessed latch system (1110) ensures a gas-tight interface between the concentric reducer shell (1000) and the workpiece (3000) by compressing a silicone gasket (1120) against the workpiece surface adjacent to the weld joint (3100). FIGS. 20 and 21 detail the gasket (1120) installation, which lines the inner surface of the receptacle (1101) and the distal edges of the shell (1000). When the workpiece (3000) is positioned within the receptacle (1101) (FIG. 22), the gasket (1120) conforms to the workpiece surface, forming a preliminary seal. Clamping a second shell (not shown) onto the opposing side of the workpiece (3000) and engaging the latches (1110) compresses the gasket (1120) uniformly, creating a hermetic seal around the weld joint (3100). This compression mechanism eliminates air gaps even on irregular surfaces, maintaining oxygen levels below 25 ppm. The system's modularity allows adaptation to varying workpiece diameters (+10%) without custom tooling, addressing a critical limitation of prior rigid shielding systems (e.g., U.S. Pat. No. 4,562,334). Additionally, this latch-gasket synergy ensures contamination-free welding across orientations while simplifying setup-key advancements over skill-dependent trailing shields like Huntingdon Fusion's Argweld® models.

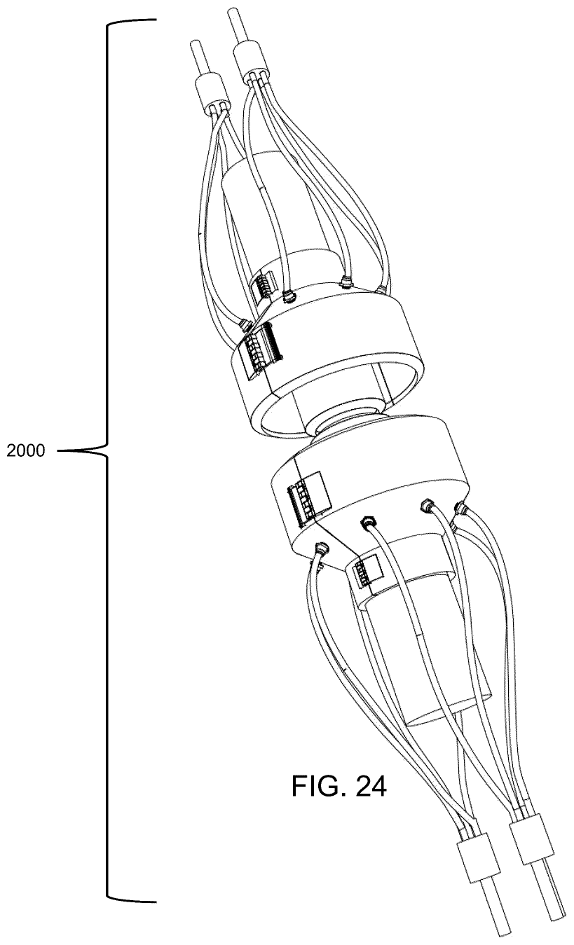

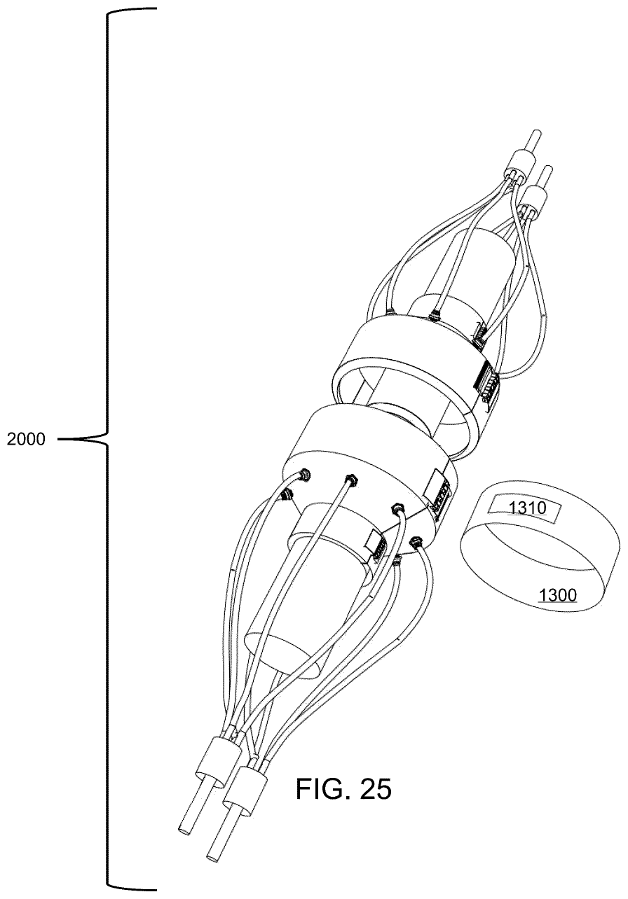

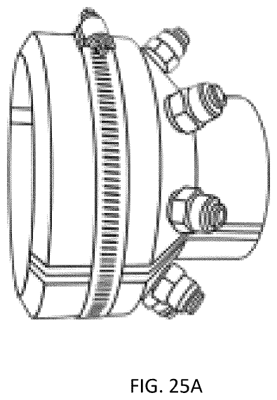

The purge chamber (2000) is assembled by securing two split-shell assemblies (1000) on either side of the workpiece (3000), with latches (1110) engaged to compress silicone gaskets (1120) against the workpiece surface adjacent to the weld joint (3100). FIGS. 1, 2, and 23-25 illustrate this configuration, where the chamber (2000) encapsulates the weld joint (3100) within the hoods (1102) of the shells (1000). A longitudinal access gap between the shells permits TIG torch entry while maintaining inert gas coverage due to laminar flow dynamics and argon's higher density relative to air, minimizing gas leakage. To further mitigate inert gas loss, heat-resistant tape (1300) (FIG. 25) seals the access gap during non-welding intervals (e.g., cooling phases or setup adjustments). The tape (1300) incorporates a transparent window (1310), optionally paired with internal LED lighting, enabling real-time weld inspection without compromising the inert atmosphere. Operators remove the tape (1300) during active welding and reapply it during pauses, ensuring continuous oxygen levels <25 ppm. Key Features of this configuration include: Laminar Flow Retention: Layered diffusers (1130/1140/1150) maintain argon density gradients, minimizing leakage through the access gap. Modular Sealing: Heat-resistant tape (1300) adapts to varying gap widths (+5 mm) while withstanding temperatures up to 500° C. Operational Flexibility: Window (1310) supports visual or automated monitoring (e.g., CCD cameras) of weld quality. This configuration resolves prior art limitations (e.g., Huntingdon Fusion trailing shields) by combining full encapsulation with operator accessibility, reducing argon waste by 40-60% compared to open shielding systems.

### Method for Eliminating Welding Contamination Using the Purge Chamber

The purge chamber (2000) resolves oxidation and contamination challenges in reactive metal welding by creating a controlled inert atmosphere around the weld joint (3100). This ensures defect-free welds on titanium, zirconium, aluminum, and other oxidation-prone metals. Below is a detailed workflow for effective implementation:

1. Pre-Welding Preparation-Begin by thoroughly cleaning the workpiece (3000) surfaces adjacent to the weld joint (3100) using acetone or a compatible solvent to remove oils, grease, and debris. Inspect the purge chamber components-including the concentric reducers (1000), silicone gaskets (1120), latches (1110), and gas distribution hoses (1210)—for integrity. Secure the aligned pipe sections using welding clamps or fixtures to prevent misalignment during chamber installation.

2. Chamber Assembly and Sealing-Open the recessed latches (1110) and position the split-shell assemblies (1000) around the workpiece (3000), ensuring the weld joint (3100) is centered within the hoods (1102). Engage the latches (1110) to compress the silicone gaskets (1120) against the workpiece, forming an airtight seal. For irregular surfaces, supplement the seal with heat-resistant tape (1300) along the guide rim (1103) to eliminate gas leakage.

3. Inert Gas Purging-Connect the main argon inlet hose (1210) to the gas distribution network (1200) and initiate argon flow at 25-35 CFH. The stainless steel wool (1130), fine mesh (1140), and perforated sheet (1150) diffusers ensure laminar gas distribution, displacing atmospheric oxygen. Monitor oxygen levels via an inline sensor until concentrations fall below 25 ppm. Adjust vent holes (1230) to maintain internal pressure at 0.5-1.5 psi, preventing over-pressurization.

4. Welding Execution and Monitoring-Perform TIG or MIG welding through the access gap between the split shells (1000), leveraging the transparent viewing window (1310) for real-time inspection. If oxidation or discoloration occurs, increase argon flow or inspect for seal breaches. The high-heat silicone padding (1120) protects the workpiece (3000) from thermal damage during prolonged welding cycles.

5. Post-Weld Protocol—For most materials, it may be desirable to maintain argon flow until the weld cools below 400° C. to prevent delayed oxidation. For Zirconium, it may be preferable to maintain inert gas flow until the weld cools to 315° C. and for Titanium 371° C. After cooling, shut off the gas supply, disengage the latches (1110), and remove the purge chamber (2000). Inspect the weld for defects and clean the chamber components for storage.

Industrial applications enabled by the purge chamber (2000) and the above described method include: Aerospace Titanium Components: Precision-welded titanium joints (3100) for airframe structures or jet engine parts, where oxidation-free seams are critical for fatigue resistance. Zirconium Nuclear Reactor Piping: Contamination-free welds in zirconium alloy coolant channels, preventing hydride-induced embrittlement in reactor cores. Beryllium-Aluminum Optical Mounts: Low-distortion welding of Be—Al alloys for satellite instrumentation, avoiding toxic oxide formation. High-Purity Pharmaceutical Vessels: Austenitic stainless steel or aluminum tanks welded under inert conditions to meet FDA-grade cleanliness standards. Additive-Manufactured Hybrid Parts: Post-print welding of titanium or niobium 3D-printed components for custom aerospace or medical implants.Technical Advantages Over Conventional Methods: Reduced Skill Dependency: Novice welders achieve 83% oxidation-free success rates (vs. 22% with trailing shields) due to static encapsulation. Gas Efficiency: Laminar flow diffusers cut argon consumption by 40-60% compared to turbulent shielding systems. Multi-Metal Compatibility: Supports welding of uranium, tantalum, and rhenium alloys for nuclear or high-temperature applications. By integrating modular encapsulation, hybrid gas workflows, and turbulence-free diffusion, the purge chamber (2000) sets a new standard for contamination-free welding across industries requiring ultra-high-purity joints.

Deficiencies of Conventional Trailing Shields-Traditional trailing shields (e.g., Huntingdon Fusion models) demand continuous operator pressure against the workpiece (3000) to maintain inert coverage, particularly challenging on thin-walled pipes where heat dissipation risks seal failure. Imperfect sealing allows atmospheric gases to infiltrate, causing oxidation, discoloration, and embrittlement at the weld joint (3100). These systems also restrict torch mobility, struggle with complex geometries (e.g., mitered joints), and require advanced operator skill, leading to frequent defects, rework, and material waste.

Purge Chamber's Encapsulation Advantage—The purge chamber (2000) resolves these issues by fully encapsulating the weld joint (3100) within a static inert environment. Unlike trailing shields, which only protect the immediate arc zone, the chamber's split-shell assemblies (1000) and silicone gaskets (1120) maintain oxygen levels <25 ppm throughout welding and cooling. This eliminates atmospheric exposure, ensuring contamination-free welds without requiring operator skill to manually adjust shielding.

Empirical Validation at Kentucky Welding Institute-Testing at the Kentucky Welding Institute compared the purge chamber (2000) against traditional trailing shields. Novice welders achieved 83% oxidation-free titanium welds with the chamber versus 22% using trailing shields. The gas distribution network (1200) and laminar flow diffusers (1130/1140/1150) maintained an inert atmosphere, preventing oxide formation on filler metals. Students reported unrestricted torch movement through the access gap, contrasting with trailing shields' rigid positioning demands.

Aluminum Welding Breakthrough—While aluminum welding typically suffers from oxide layers (Al₂O₃ melting point: 3,680° F. vs. base metal: 1,218° F.), the purge chamber (2000) eliminates this issue. By enclosing the weld joint (3100) and heat-affected zone (HAZ) within an argon-rich hood (1102), the chamber prevents oxide nucleation. This enables clean, spatter-free aluminum welds-critical for aerospace and automotive applications.

Operational Flexibility and Torch Control—The purge chamber's (2000) recessed latches (1110) and guide rim (1103) allow unhindered torch access, unlike trailing shields that constrain welder movement. During testing, novices could reposition the torch without breaking inert coverage, even with unsteady hands. The chamber's static design ensures uniform argon flow (25-35 CFH) via the gas distribution network (1200), eliminating manual pressure adjustments.

Enhanced Training and Usability—At the Kentucky Welding Institute, trainees welding titanium with trailing shields struggled to maintain shield contact, risking oxidation. The purge chamber (2000) resolved this via its self-sealing split shells (1000) and silicone gaskets (1120). The transparent window (1310) provided real-time visibility, enabling trainees to correct techniques without contamination—a critical advantage for reactive metals like zirconium and beryllium-aluminum.

Real-Time Quality Assurance—The purge chamber's (2000) viewing window (1310), augmented by optional LED lighting, allows welders to detect defects (e.g., porosity, undercut) during deposition. This contrasts with trailing shields, which obscure the weld pool. For aluminum, the chamber's oxide-free environment reduces post-weld grinding, while for titanium, it prevents the brittle α-case layer that plagues conventional methods.

Technical Superiority-Gas Efficiency: Laminar flow via diffusers (1130/1140/1150) reduces argon use by 40-60% vs. trailing shields. Multi-Metal Compatibility: Validated for Zr, Hf, Be—Al, Ta, and U alloys. Skill Democratization: 83% novice success rate vs. 22% with trailing shields. By integrating full encapsulation, turbulence-free flow, and modular adaptability, the purge chamber (2000) redefines reactive metal welding across aerospace, nuclear, and additive manufacturing sectors.

The purge chamber (2000) comprises modular components designed to create a sealed inert environment for welding reactive metals. Central to the system are concentric reducers (1000), fabricated from heat-resistant PVC or polymer, split longitudinally to clamp around the workpiece (3000). These reducers (1000), sized for compatibility with 2″ SCH 80 piping, integrate a recessed latch system (1110) positioned 180° apart to ensure airtight closure. The latches (1110) compress high-heat silicone padding (1120) against the workpiece, forming a gas-tight seal while accommodating ±10% diameter variance.

Gas distribution is managed via a network of eight ¼″ clear flexible hoses (1210) connected to a ¾″ main argon inlet (1210). A four-to-one manifold (1220) ensures uniform argon flow, while stainless steel wool (1130) and fine mesh screens (1140) within the hood (1102) eliminate turbulence, achieving laminar flow (<2,000 Reynolds number). Optional vent holes (1230) regulate internal pressure (0.5-1.5 psi) to prevent over-pressurization.

User accessibility is enhanced by a purge chamber gap between reducers (1000), permitting TIG torch access to the weld joint (3100). Heat-resistant tape (1300) seals this gap during non-welding intervals, and a transparent polycarbonate window (1310) allows real-time inspection. For multi-pass welding, quick-release latches (1110) enable rapid chamber repositioning without breaking inert coverage.

Additional components include threaded barbed fittings (1230) for secure hose connections and optional adjustable brackets for stabilizing the chamber on irregular workpieces. The system's adaptability extends to hybrid workflows, where auxiliary ports (1230) inject reactive gases like CCl₄ for in-situ oxide removal.

System Synergy-Structural Integrity: Concentric reducers (1000) and latches (1110) form a rigid enclosure, isolating the weld joint (3100) from atmospheric gases. Gas Control: Argon flows from the inlet (1210) through the manifold (1220) and diffusers (1130/1140), ensuring <25 ppm oxygen levels. Operational Flexibility: The access gap and window (1310) allow unrestricted torch movement and visual monitoring, critical for complex geometries. Sealing Redundancy: Silicone padding (1120) and heat-resistant tape (1300) provide dual sealing mechanisms, preventing leaks even in high-temperature environments. This integrated design reduces argon consumption by 40-60% compared to trailing shields, democratizes operator skill requirements, and ensures contamination-free welds across titanium, zirconium, and aluminum applications.

Operational Mechanics of the Purge Chamber-he purge chamber (2000) maintains a contamination-free welding environment by fully encapsulating the weld joint (3100) within an argon-rich atmosphere. Concentric reducers (1000), split longitudinally and secured via a recessed latch system (1110), form a sealed enclosure around the workpiece (3000). Argon gas enters through the main inlet hose (1210), flows into a four-to-one manifold (1220), and distributes evenly via eight ¼″ hoses (1210) to ensure uniform coverage. Stainless steel wool (1130) and fine mesh diffusers (1140) eliminate turbulence, achieving laminar flow (<2,000 Reynolds number) critical for oxygen levels below 25 ppm.

Heat-resistant tape (1300) seals the access gap between reducers (1000), permitting TIG torch entry while minimizing gas leakage. Transparent viewing windows (1310), integrated into the hood (1102), enable real-time weld monitoring without disrupting inert conditions. Adjustable vent holes (1230) regulate internal pressure (0.5-1.5 psi), preventing over-pressurization during multi-pass welding. High-heat silicone padding (1120) lines the receptacle (1101), protecting the workpiece (3000) from thermal damage while enhancing seal integrity.

This integrated system eliminates oxidation in titanium, zirconium, and aluminum welds by combining static encapsulation, turbulence-free gas distribution, and modular accessibility-resolving the skill dependency and gas waste inherent in trailing shields.

A fabrication methodology for constructing a shell (1000) includes the steps of: Concentric Reducers (1000) Preparation-Split PVC or polymer reducers longitudinally and smooth edges to prevent seal breaches. Install recessed latches (1110) on both halves, ensuring alignment for airtight closure. Gas Distribution Assembly-Drill eight equidistant ports at the hood's (1102) transition angle (2″ to 4″ diameter). Thread barbed fittings (1230) into the ports and connect ¼″ hoses (1210) to a manifold (1220). Insert stainless steel wool (1130) and fine mesh (1140) into the hood (1102) to diffuse argon streams. Sealing System Integration-Apply silicone gaskets (1120) to the receptacle (1101) and distal edges of the reducers (1000). Secure adjustable brackets (if used) to stabilize the chamber on irregular workpieces. Functional Testing-Pressurize the chamber (2000) with argon at 25-35 CFH, checking for leaks at latches (1110) and hose fittings (1230). Conduct trial welds on titanium samples, verifying oxidation-free results via the viewing window (1310).

Optional Enhancements for the shell (1000) include: Vented Shells (1230 (FIG. 2)): Ports on the upper reducer (1000) allow passive argon venting in vertical orientations, leveraging gas density for efficient oxygen displacement. Modular Clamps (1110): Supplementary clamps stabilize the chamber (2000) on thin-walled or vibrating workpieces. Robotic Mounting

Brackets: Aluminum brackets align the chamber (2000) with automated welding systems for additive manufacturing or nuclear pipe welding. Reactive Gas Ports (1230): Auxiliary fittings enable CCl₄/HCl injection for in-situ oxide removal per Jordan's method (U.S. Pat. No. 2,576,793). These enhancements broaden the purge chamber's (2000) applicability across aerospace, nuclear, and hybrid manufacturing workflows while retaining core functionality.

Core Components and System Integration—The purge chamber (2000) comprises concentric reducers (1000)—split PVC or polymer shells clamped around the workpiece (3000) via a recessed latch system (1110). The reducers (1000) encapsulate the weld joint (3100) within a hood (1102), sealed by silicone gaskets (1120) and heat-resistant tape (1300). Argon flows through a ¾″ main inlet (1210), distributing via eight ¼″ hoses (1210) connected to a manifold (1220). Stainless steel wool (1130) and fine mesh diffusers (1140) ensure laminar flow (<25 ppm O₂) across the weld zone. A transparent viewing window (1310) allows real-time inspection, while vent holes (1230) regulate internal pressure (0.5-1.5 psi). Optional Enhancements—To expand functionality, the chamber (2000) supports modular adaptations: Automated Gas Control: Integrated flow sensors and smart valves (1230) adjust argon distribution dynamically, reducing waste. Hybrid Gas Compatibility: Auxiliary ports (1230) enable helium or nitrogen injection for specialized alloys (e.g., beryllium-aluminum). Magnetic Positioning: Neodymium strips secure reducers (1000) to ferrous workpieces without clamps.Multi-Zone Purging: Segmented hoods (1102) isolate weld sections for complex geometries. AI-Driven Monitoring: Wireless sensors relay oxygen levels and thermal data to a mobile interface, enabling remote adjustments. There are also alternative configurations, including: Material Flexibility: Replace PVC reducers (1000) with carbon fiber or titanium-coated alloys for extreme heat resistance. Other materials include plastic mold injections, heat resistant polymers, plastic printing, fiberglass, composite materials, PVC materials, and etc. Gas Delivery Innovations: Substitute hoses (1210) with micro-channeled manifolds (1220) molded into the hood (1102). Modular Scalability: Telescoping reducers (1000) adapt to pipe diameters from 1″ to 6″ via interlocking segments. Rotational Systems: Motorized hoods (1102) rotate synchronously with orbital welding arms for circumferential joints. Vacuum Sealing: Replace silicone gaskets (1120) with suction-based seals for irregular surfaces.

Structural and Safety Upgrades: Self-Purging Mechanism: A vacuum pump (1230) evacuates residual oxygen before argon injection. Thermal Management: Water-cooled walls (1120) dissipate heat during prolonged welds. Emergency Protocols: Pressure-relief valves (1230) and auto-shutdown sensors (1230) prevent over-pressurization. Augmented Reality (AR): A heads-up display projected onto the window (1310) overlays weld parameters (amperage, gas flow). The purge chamber (2000) has various versions of industrial adaptability, including: Additive Manufacturing: Mount the chamber (2000) on robotic arms for contamination-free wire-arc AM of titanium. Field Repairs: A collapsible frame with ergonomic handles enables rapid deployment in offshore or remote settings. Multi-Metal Welding: Interchangeable diffuser cartridges (1130/1140) optimize gas flow for aluminum, zirconium, or uranium. By integrating core components (1000-1310) with modular enhancements, the purge chamber (2000) resolves prior art deficiencies in gas efficiency, operator skill dependency, and contamination control. Its adaptability across aerospace, nuclear, and additive manufacturing applications establishes a new benchmark for reactive metal welding.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus, the breadth and scope of the claimed invention should not be limited by any of the above-described embodiments. Adaptability and Cross-Industry Applications of the Purge Chamber—The purge chamber (2000), while described in the context of welding reactive metals, is not limited to the embodiments detailed herein. Features such as the concentric reducers (1000), gas distribution network (1200), and recessed latch system (1110) can be combined or reconfigured across applications, whether or not explicitly depicted. For instance, the laminar flow diffusers (1130/1140/1150) and modular sealing mechanisms (1120/1300) may be adapted to non-welding environments requiring controlled atmospheres. Below are transformative applications beyond conventional welding: Aerospace & Aviation—The chamber's inert environment is critical for welding titanium aircraft components (e.g., jet engine mounts) and fabricating spacecraft structures under vacuum-like conditions. Its silicone gaskets (1120) and gas-tight seals prevent oxygen ingress during repairs or manufacturing of aerospace-grade alloys.

Semiconductor & Electronics-adapted for semiconductor fabrication, the purge chamber (2000) could shield microchip bonding processes from moisture and airborne contaminants. The transparent viewing window (1310) and argon shielding would enhance precision in circuit board soldering, eliminating oxidation on nanoscale joints. Medical & Biotechnology—In medical implant manufacturing, the chamber's controlled atmosphere ensures oxidation-free welding of biocompatible titanium prosthetics. Modified with sterile filtration, it could create bacteria-free environments for lab-grown tissue engineering or bioassay preparation. Food & Beverage Processing-Retrofitted with vacuum-sealing capabilities, the chamber (2000) could purge oxygen from food packaging, extending shelf life. For fermentation, its gas distribution network (1200) might maintain nitrogen-rich environments for anaerobic brewing processes. Additive Manufacturing-Integrated with 3D metal printers, the chamber (2000) provides an oxygen-free zone for laser sintering of titanium or aluminum powders. Hybrid welding-printing workflows could leverage its laminar flow diffusers (1130/1140) to prevent interlayer oxidation. Energy & Nuclear Systems—For nuclear reactor piping, the chamber's static encapsulation ensures contamination-free welding of zirconium alloy coolant channels. In hydrogen fuel cell production, its gas shielding prevents embrittlement during platinum-coated bipolar plate joining. Automation & AI Integration-Paired with robotic welding arms, the chamber (2000) could autonomously adjust argon flow via IoT-enabled sensors (1230). Machine learning algorithms might optimize gas pressure (0.5-1.5 psi) in real-time, reducing waste by 40-60% compared to manual systems. Additional advancements—The purge chamber system offers significant potential for advanced integrations that would enhance its capabilities in specialized applications. These innovations include AI-driven gas mixing systems capable of creating precise Ar/He blends, self-purging vacuum systems integrated within component 1230, and augmented reality overlays displayed through the viewing window 1310. Such technological enhancements would significantly expand the chamber's utility in high-precision manufacturing environments, particularly in quantum computing component assembly and nanomaterial synthesis applications. Through these advanced capabilities, the purge chamber 2000 transcends its original design parameters, demonstrating exceptional versatility across industries that demand contamination-free environments. This positions the system as a foundational tool for next-generation manufacturing and cutting-edge research applications.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

Fittings and Pipe Geometry Accommodation: The purge chamber apparatus demonstrates exceptional engineering adaptability, designed to accommodate virtually any pipe fitting geometry encountered in industrial applications. The system can be configured to create effective seals around various fitting types, including 45° and 90° elbows, concentric and eccentric reducers, T-fittings, flanges, OLETs, and numerous other external fitting configurations. The technical documentation illustrates specific embodiments for different geometries: FIGS. 26A-F demonstrate the 45-degree elbow configuration, FIGS. 27A-G show the 90-degree elbow implementation, FIGS. 28A-D present the flange accommodation design, and FIGS. 35A-M detail the OLETS configuration. Additionally, FIG. 37 shows an embodiment featuring a hub specifically designed for installing chambers around t-fitting configurations. With appropriate segmental modules or internal-radius diameter adjustments, the system can conform to these same geometric shapes on the interior surfaces of pipes and vessels, enabling both external shielding and internal back-weld purging operations without requiring custom fixtures.

Segmental & Partial-Coverage Configurations: The purge chamber system offers innovative flexibility through custom-arc segment configurations that expand beyond the traditional design approach. Instead of the standard configuration that combines two 180° bodies to form a complete 360° circumference purge chamber, the system can be offered as interchangeable arc segments in various configurations, including 60°, 90°, 120°, and 180° segments, as illustrated in FIG. 38. Each individual segment incorporates its own inlet system, diffuser mechanism, and gasket material, operating as an independent purge chamber apparatus. These segments do not require completion of a full 360° configuration to provide effective protection, unlike the traditional Purge Chamber Apparatus shown in FIGS. 1-25. This independent design approach allows for an extensive assortment of variations, including different arc segment configurations and miniaturized versions to accommodate diverse application requirements.

The Internal-Radius Variant represents a significant advancement from the embodiment described in FIGS. 1-25, which focuses on split-shell chambers that seal around the outside diameter of pipe sections only. This variant is specifically engineered to follow the inside contour of piping and pressure vessels, enabling true back-welding and targeted purge operations within enclosed bores, as shown in FIGS. 34A-J. The system offers several key advantages, including precision back-welding capabilities that allow welders to perform back welds or repairs from within the pipe or vessel. The localized purge control feature distinguishes it from bladder bags, foam pigs, or water-soluble dams that either fill the entire pipe or vessel bore or leave residue behind. The internal-radius variant isolates and purges only the immediate weld zone, consuming significantly less inert gas while avoiding contaminant-laden runoff. The system achieves rapid, high-quality purge performance, bringing the small internal volume created by the inside diameter variant below 100 ppm oxygen in under 60 seconds, even in large-diameter lines, by injecting gas directly into the minimal cavity around the weld. The design ensures residue-free and clean operation because no tapes, gels, or soluble materials contact the weld surface, eliminating any risk of adhesive or particulate contamination entering the joint. The purge chamber apparatus and body can be constructed as rigid, elastomeric, or both, and may include inflatable sealing members to provide superior sealing inside the diameter of the pipe or vessel. The Internal-Radius Variant transforms the purge chamber into a versatile tool for internal purging and back-welding, delivering faster, cleaner, and more efficient inert-gas protection precisely where needed.

### Recessed Mechanical Latches

The original design shown in FIGS. 1-25 utilized recessed mechanical latches, an approach that increased part count, manufacturing complexity, and created a more complex purge chamber apparatus with additional moving parts. The solution involved replacing the latching scheme of FIGS. 1-25 with simpler, more reliable sealing methods. The Rigid-Body Variants eliminate recessed mechanical latches by using a stainless-steel band clamp that wraps around the purge chamber body and tightens to form an effective seal, as shown in FIGS. 36A-E. The Elastomeric-Flex Variants feature a chamber outer shell made from flexible elastomeric material that simply wraps around the part and folds back onto itself, creating a continuous, gas-tight seal without requiring any hardware, as illustrated in FIGS. 35A-E and FIGS. 29A-29I. Hybrid Rigid-Elastomer Assemblies combine a rigid frame with the same wrap-around elastomeric material, allowing operators to “fold back” the elastomer onto itself to seal while gaining added structural support from the rigid sections, as shown in FIGS. 35F-M.

The system also incorporates Inflatable Sealing Members, featuring elastomeric bladders or dual-cuff systems integrated into the chamber. When inflated with inert gas, these components expand to press tightly against the workpiece, delivering a uniform, high-integrity seal, as demonstrated in FIGS. 33A-F for external applications and FIGS. 34A-J for internal applications. Other Strap- and Band-Based Options include silicone straps or bands complete with eyelets and simple hook-or-hood latching systems that attach to tabs on the chamber body, wrap around the pipe or fitting, and secure on the opposite side. Alternatively, a full silicone “wrap-around” body can encircle the part and hold itself in place, as shown in FIGS. 29A-29I. The system utilizes magnetism through rare-earth magnets embedded in the chamber body or molded into the elastomeric wrap, providing secure, tool-free attachment to ferrous piping. These magnets also allow individual chamber segments to snap together quickly, maintaining alignment and seal integrity without clamps or latches. When used in the flexible elastomeric variant, magnetic elements within the wrap enable the sleeve to fold around the pipe and hold itself in place, creating a reliable, reusable, and contamination-free seal. Each of these approaches eliminates complex moving latches, reduces part count, and enables faster, tool-free setup and maintenance in field applications.

Tape Sealant with Viewing Window

The embodiment shown in FIGS. 1-25 relied on heat-resistant tape complete with a viewing window to seal the torch access gap. Unfortunately, this tape often leaves adhesive residue on the chamber body, creating contamination risks to the inert atmosphere and the weld itself. To eliminate this problem, a “Slap-Bracelet Sealing Concept” is utilized, featuring a spring-steel band that instantly wraps around the chamber opening and snaps into place. This single component replaces tape usage, providing quadrant access to perform welding without tape leaving residues.

### Quick Connect Adapters

The embodiments shown in FIGS. 1-25 specify quick-connect adapters that must be installed by drilling into the chamber body, tapping threads, and threading the adapters into place. As an alternative, barbed hose fittings can be used instead, either screwed in to replace the quick-connect adapters or molded directly into the chamber body during manufacture. By eliminating the need to drill holes and tap threads, this approach reduces manufacturing steps and costs, minimizes potential leak paths, and simplifies production. The design also yields a slimmer overall profile, allowing the purge chamber to fit into tighter or more restrictive work areas without the bulk of traditional quick-connect fittings.

### Body

The High-Temperature, Modular Design improvements of the Purge Chamber apparatus include field-swap modules made from materials engineered for extreme heat performance and rapid on-site reconfiguration. The Chamber body may be composed fully of flexible elastomers, or by combining both Rigid Composites and Elastomeric Flex materials. Rigid Composites consist of load-bearing modules built from refractory ceramics, high-performance thermoplastics, or fiber-reinforced composites for mechanical strength and thermal resilience. Elastomeric Flex variants are fully flexible mats molded from high-temperature silicones or premium elastomers to conform around cables, gussets, OLETs, and irregular contours, sealing up to approximately 320° C. Hybrid Modules represent custom assemblies that combine rigid frames with elastomeric seals to deliver both structural support and gas-tight performance in the harshest environments. Inflatable Sealing Members allow the Purge Chamber body to be rigid or elastomeric material, while the remaining body for seal consists of elastomeric bladders or dual-balloon cuffs, pressurized with inert gas, adapting to non-cylindrical geometries and complex surfaces, achieving superior seals at service temperatures up to approximately 300° C.

The chamber body can be fabricated from various rigid, load-bearing materials selected against stringent mechanical, thermal, and chemical criteria-materials traditionally reserved for metallic components. Options include refractory ceramics for excellent thermal-shock resistance, high-performance thermoplastics such as PEI, PPS, and PEEK valued for their strength-to-weight ratios, chemical stability, and continuous use up to 260° C., and fiber-reinforced composites in which a polymer or ceramic matrix is bolstered by glass, ceramic, or graphite fibers plus tailored additives to enhance stiffness, abrasion resistance, and thermal conductivity.

To achieve an airtight inert-gas seal around complex geometries including heat-trace cables, debris, gussets, supports, OLETs, padding, stray attachments or irregular pipe contours, the chamber body is molded from advanced elastomeric compounds. In its fully flexible form, a flat mat with an integrated sealing flange is made from high-temperature silicone rubber or other premium elastomers including fluorosilicone, Viton® FKM, EPDM, perfluoroelastomers like Kalrez®, or PTFE-coated variants. Simply unroll the mat around the pipe or vessel and press it into place: the elastomer conforms to every surface irregularity, delivering a superior seal up to approximately 320° C. When welding is finished, the mat rolls back up for compact storage and instant redeployment on the next joint.

For the most demanding environments involving continuous operation above 320° C. or exposure to aggressive chemicals, UV, or radiation, the chamber combines rigid, load-bearing modules with flexible sealing inserts. Rigid sections are made from materials chosen against rigorous mechanical and thermal criteria such as refractory ceramics, high-performance thermoplastics, and fiber-reinforced composites to carry structural loads and resist heat flux. Elastomeric inserts, molded from high-temperature silicones or premium elastomers including fluorosilicone, Viton® FKM, EPDM, Kalrez®, and PTFE-coated variants, conform to complex geometries and maintain an airtight seal. Together, these hybrid modules deliver chemical inertness, minimal off-gassing, ozone/UV stability, and protection against contaminants like sulfur compounds on stainless, titanium, or zirconium welds.

In alternative embodiments, particularly when sealing irregular or non-cylindrical geometries, the purge enclosure, whether rigid or elastomeric, may include one or more inflatable or otherwise expandable sealing members such as elastomeric bladders, dual-balloon cuffs, or fabric-reinforced pneumatic bags, as shown in FIGS. 33A-F. Upon pressurization with inert gas or air, these members conform tightly to the work-piece surface, thereby creating a superior gas-tight seal. Depending on the design, a controlled portion of the inert gas may be permitted to enter the purge chamber to supplement atmospheric purity. These inflatable assemblies may be constructed from high-temperature silicones, fluoroelastomers, or woven glass fabrics coated with heat-resistant polymers, allowing service temperatures up to approximately 300° C. subject to the specific material selected. The sealing element thus comprises an inflatable bladder or expandable cuff that, when expanded, defines said gas-tight seal.

For internal purge-chamber apparatus, whether elastomeric material, or if the apparatus includes an inflatable/expandable body variant, there is an embodiment that allows it to completely enclose or “wrap” a full 360 degrees on the inside diameter of the pipe or vessel. This enables the inflatable member to be pressurized, filling the expandable body and creating a tight seal, as shown in FIGS. 34A-J. Inert gas can be used to inflate or “pressurize” the expandable body, and depending on the design, a controlled portion of the inert gas may again be permitted to enter the purge chamber to supplement atmospheric purity.

For internal purge-chamber apparatus whether elastomeric material or that includes an inflatable/expandable body variant and encircles the full 360 degrees of piping, an additional embodiment includes a “+” cross-support with a hole in the middle, allowing opposing purge chambers facing each other to be securely fastened together. Additionally, a cope or other attachment means can be connected to the “+” support, enabling the internal-diameter purge-chamber apparatus to be pulled through piping for alignment or relocation purposes. This purge chamber can be used for back-purging piping or vessel sections, allowing operators to focus on a small area, specifically purging the immediate weld zone and heat-affected zone.

Alternatively, as piping increases in diameter, an internal purge-chamber apparatus designed to cover limited quadrants, such as 90-degree sections or other fractional portions of the pipe circumference, can be combined with additional quadrant-specific purge-chamber segments to achieve a full 360-degree protective purge environment. For example, four individual 90-degree internal purge-chamber segments can be assembled together, completely encircling the internal circumference, and secured using a “+” shaped cross-support or similar multi-branched structural support.

Further Upgrades that can be implemented into the Purge Chamber apparatus: Further upgrades to the purge chamber apparatus may include adapting it into a specialized trailing-shield variant. This involves miniaturizing the chamber body, integrating it directly with a TIG or TIP-TIG torch, and incorporating transparent viewing ports-potentially utilizing see-through materials such as borosilicate glass—to improve visibility of the weld puddle. The resulting compact, torch-mounted trailing shield would offer a quick-disconnect interface, precision diffuser system, and ergonomic handling, ensuring continuous, localized inert-gas coverage essential for high-purity welding operations. Future designs of this trailing shield may further incorporate advanced, high-temperature materials, modular diffuser cartridges for easy replacement, and enhanced viewing areas, ultimately providing greater shielding effectiveness, improved weld quality, and increased operator convenience.

Advanced thermal-management solutions may be integrated directly within the purge chamber body to provide precise, reliable control of welding temperatures and significantly enhance operational efficiency and safety. These advanced integrated features may include embedded aluminum or copper heat sinks, designed to rapidly dissipate heat uniformly throughout the chamber, thereby maintaining stable chamber temperatures. Graphite heat exchangers may be incorporated to offer highly efficient heat transfer and distribution, effectively mitigating thermal hotspots that can negatively impact weld quality and chamber longevity. Specialized phase-change materials (PCM) can be strategically integrated into the chamber structure to absorb and release thermal energy, ensuring precise control over inter-pass temperatures and enhancing overall welding consistency.

For high-intensity welding applications, the chamber body may include water, fluid or gaseous circulation channels within the chamber body, providing an active cooling mechanism to dynamically manage sustained high-temperature operations. An internally embedded plug-in thermal heating cable can optionally be integrated within the body, chamber, or gasket assembly, delivering precise preheating capabilities. This heating cable delivers precise preheating capability, significantly reduces thermal shock, minimizing material stresses that could lead to cracking or distortion, particularly crucial for welding reactive metals such as titanium, zirconium, or specialized stainless steels.

The internal heating system ensures precise and uniform thermal management throughout the chamber body, gasket, or chamber surfaces, consistently enhancing weld quality, minimizing contamination, by effectively eliminating moisture and volatile impurities, accelerating the reduction of oxygen and moisture levels within the purge environment, and significantly enhancing overall welding productivity. In colder climates or environments, this internal heating capability further ensures the maintenance of a minimum inter-pass temperature, preventing undesirable temperature drops that could adversely affect weld integrity and consistency. Additionally, embedding the heating cable internally improves operator safety by keeping external surfaces at safer temperatures, thereby reducing the risk of accidental burns and eliminating the need for external preheating devices. Enhanced thermal management through internal heating also reduces thermal cycling stress on gasket materials, significantly extending their operational lifespan, reducing downtime, and lowering maintenance requirements.

Alternatively, a plug-in active cooling cable system, featuring embedded fluid or gaseous circulation channels or thermoelectric cooling elements, may optionally be integrated within the purge chamber body. This cooling system actively removes excess heat from the weld area, effectively managing inter-pass temperatures, significantly reducing thermal distortion, minimizing heat-related defects, enhancing operator safety, and improving welding productivity and chamber durability. Complementing these thermal management solutions, real-time thermal monitoring sensors can be embedded within the chamber's body structure, continuously measuring body temperature and thermal gradients to work synergistically with gasket diagnostics, providing comprehensive thermal oversight.

Integrated smart control modules can automatically regulate heating and cooling rates based on real-time sensor feedback, optimizing welding conditions, ensuring high metallurgical quality, and extending the lifespan of chamber components. Modular thermal insulation panels may also be optionally integrated internally or externally, further enhancing thermal efficiency, reducing energy consumption, protecting operators from thermal exposure, and promoting long-term component durability. Collectively, these thermal management innovations, including both internally embedded plug-in heating cables and active cooling cable systems, substantially improve welding outcomes by delivering precise, adaptive, and reliable control of critical temperature parameters, representing a meaningful advancement in purge chamber technology.

### Gasket Concept

For rigid-body variants where the chamber body is made from non-elastomeric materials, the gasket remains a distinct elastomeric component. When the entire purge chamber including both body and gasket is constructed from the same elastomeric material, however, the gasket simply becomes part of the chamber body. In other words, a separate gasket only exists when it is made of a different material than the body; if both share the same elastomer, the gasket is integral to the body itself.

The purge chamber system further incorporates a modular, consumable high-temperature gasket assembly specifically engineered from advanced silicone-based elastomeric materials, explicitly selected for sustained exposure to elevated welding heat cycles. This gasket system features an innovative modular snap-in insert design, securely engaged within precision-engineered retention grooves, enabling rapid, tool-free replacement directly in the field without requiring chamber disassembly-thereby significantly enhancing operational efficiency, minimizing downtime, and improving overall serviceability.

Suitable gasket materials include, but are not limited to, high-temperature silicone rubber, Fluorosilicone (FVMQ), Viton® (FKM), Ethylene Propylene Diene Monomer (EPDM), Perfluoroelastomers (FFKM/Kalrez®), and PTFE-coated elastomers, each deliberately selected for distinct application-specific advantages such as chemical inertness, exceptional resistance to fuels and solvents, superior ozone and ultraviOLET (UV) stability, and minimal off-gassing.

For sustained operating temperatures beyond approximately 327° C. (620° F.), where elastomeric materials typically cannot reliably perform, alternative gasket materials such as flexible graphite (up to approximately 450-500° C. continuous, approximately 600° C. peak), ceramic fiber or silica-based gaskets (up to approximately 1000-1200° C.), mica-based gaskets (up to approximately 900-1000° C.), or metal-based gaskets such as spiral-wound or metal jacketed designs (exceeding 1000° C., depending on the alloy) can be utilized. These alternative materials provide superior chemical resistance, thermal stability, and mechanical performance, making them ideal for reliably sealing in extreme operational environments encountered during reactive metal welding.

The chemical resistance and inertness attributes provided by gasket materials are particularly essential when welding highly reactive metals such as titanium and zirconium. These metals demand stringent protection against contaminants, including chlorine, fluorine, sulphur, and phosphorus, which can significantly compromise metallurgical integrity. The elastomeric gasket materials suitable for reactive metal welding typically exhibit sustained thermal operating capabilities ranging from approximately 150° C. (Ethylene Propylene Diene Monomer) up to approximately 327° C. (Perfluoroelastomers). Under normal welding conditions, these gaskets will experience temperature fluctuations as materials cyclically heat up and subsequently cool down, allowing precise selection tailored to specific operational requirements. For conditions of continuous use where temperatures are held, and exceed approximately 327° C. (620° F.), alternative gasket materials such as flexible graphite, ceramic fiber, silica-based, mica-based, or metal-based gasket designs are recommended due to their superior thermal stability and resilience in extreme environments.

The gasket assembly may optionally incorporate embedded temperature sensors or intelligent diagnostic elements, enabling continuous real-time monitoring of gasket performance, environmental conditions, and pipe temperatures throughout welding operations. Such integrated sensors proactively identify risks related to thermal or chemical degradation, ensuring optimal welding conditions. By preventing overheating, thermal degradation, and metallurgical defects, the sensors significantly enhance operational safety and reliability. Additionally, the monitoring system supports predictive maintenance, compliance tracking, industry standards traceability, optimal inert gas utilization, and improved overall operational efficiency. Furthermore, optional modular thermal insulation packages can be integrated seamlessly with the gasket assembly to enhance thermal efficiency, improve operator safety, and extend gasket longevity, further contributing to reliable and efficient reactive metal welding operations.

Reducer Materials & Properties: For both rigid composites, elastomeric flex and hybrid modules where combining both rigid and elastomeric materials, concentric reducers for the purge chamber can be produced from rigid or elastomeric materials, using precision techniques tailored to each material and geometry. Common manufacturing methods include injection molding for complex polymer components, precision machining for tight-tolerance parts, and additive manufacturing (3D printing) for intricate or low-volume pieces. Depending on the design complexity, selected materials, and required production volume, additional processes such as rotational molding, compression molding, filament winding for composite tubes, extrusion, hybrid machining-plus-molding workflows, and precision casting may also be employed.

Elastomeric body components, including high-temperature silicone or fluoroelastomer seals and reducers, begin as compounded rubber stock that's calendered or extruded into sheets. These sheets are then shaped in heated molds via compression or transfer molding. A final post-cure vulcanization cycle completes the cross-linking, after which finished elastomeric parts are trimmed, inspected, and packaged for rapid field deployment.

Manufactured from a wide variety of advanced materials, deliberately selected based on critical performance factors such as temperature extremes, chemical exposure, mechanical strength, operational lifespan, flexibility, sealing requirements, and contamination control. Suitable materials may further include metal alloys (stainless steel, aluminum alloys, titanium alloys, nickel alloys), advanced ceramics (alumina, zirconia, silicon carbide, silicon nitride), engineering thermoplastics (PEEK, PPS, PTFE-based materials), elastomers (high-temperature silicone rubbers, fluorosilicone, Viton® FKM, EPDM, perfluoroelastomers such as Kalrez®, and PTFE-coated elastomer compounds), and hybrid composites (carbon fiber-reinforced polymers [CFRP], Kevlar®-reinforced polymers, basalt fiber composites).

In certain high-temperature or abrasive environments, the chamber body or select modules thereof may be fabricated from metallic materials, including but not limited to austenitic stainless steels (e.g., 316L), nickel-based super-alloys (e.g., Inconel 625), titanium, or aluminum. Metallic bodies provide continuous service above 500° C. and allow the enclosure to be integrated into pre-existing metallic fixtures via welding, bolting, or threaded connections. The need for metallic materials will be based upon factors such as maximum continuous operating temperature (i.e. where elastomeric or polymeric options no longer retain their sealing properties), exposure to abrasive or erosive media, required mechanical strength and pressure-containment, integration with pre-existing metallic fixtures (welding, bolting or threaded interfaces), and specific chemical-corrosion or compatibility demands.

Reducers and body are fabricated using carefully selected reinforced polymer composites, high-performance elastomers, and rigid composite materials tailored specifically for critical welding environments. Each material is rigorously assessed and chosen based on its ability to minimize contamination risks, ensure chemical inertness, and reduce off-gassing. All selected materials must undergo thorough evaluation and certification to confirm the absence of harmful constituents-including sulfur, sulfates, chlorides, fluorides, and phosphorus-containing compounds—as these contaminants can severely compromise metallurgical integrity, particularly when welding stainless steels, titanium, zirconium, or other reactive and corrosion-sensitive alloys.

The purge chamber's gas distribution system features a modular, cartridge-based diffuser assembly with removable, interchangeable diffuser elements, including options such as stainless-steel wool, fine mesh screens, perforated diffuser plates, spherical metallic or plastic BBs, structured metal foams, and advanced porous media. Spherical BBs and advanced porous media provide randomized gas diffusion pathways, ensuring uniform inert gas distribution, significantly reducing clogging or compression issues associated with conventional fibrous materials. Modular cartridge design facilitates simple in-field servicing, cleaning, and precise adjustments of gas velocity and turbulence without requiring complete chamber disassembly, thus enhancing operational flexibility, reliability, and reducing downtime. Diffuser elements may further incorporate integrated real-time gas quality sensors to continuously monitor oxygen and moisture levels, providing instantaneous feedback to operators, ensuring weld zone purity, and enabling immediate proactive adjustments.

Versatility & Joint Configurations: The purge chamber is conceptually designed for extensive versatility. Intended to accommodate a wide range of weld joint configuration, including various pipe to pipe/fitting configurations. These include full-size rigid body configurations where each segment is 180 degrees, coming together to form a full 360 degrees of coverage. Independent variants do not require full 360 degree coverage, but each arc whether 180 degrees, more or less is ‘self contained’ and acts as an independent purge chamber. FIG. 36A-36E. Mini versions of different configurations are available, as well as half rigid body, half elastomeric material (i.e., Silicone) that allows the silicone to wrap around piping, vessel or irregular shaped objects. See FIGS. 30A-32F. Independent versions and mini versions composed for different degrees of coverage, independent version strapped around the pipe adhered by a strap around the body, fully elastomeric material (i.e., Silicone) entirely made of a flexible material that can wrap around irregular shapes for better fit and accommodation, flexible silicone wrap around version purge chamber, internal radius purge chamber variant for inside diameter of piping and vessels, variants that include inflatable sealing members, an internal-diameter (ID) purge chamber apparatus comprising a full 360-degree enclosure for welding or purging vessel and piping ID, and an internal-diameter (ID) purge chamber apparatus comprising a full 360-degree enclosure and further including a structural “+”-shaped cross support with a central aperture, configured to enable opposing purge chambers facing one another to be securely attached-such as via bolted connections—and/or to facilitate pulling or positioning the purge chamber assembly within piping using a rope or similar pulling means. See, e.g., FIGS. 34A-34E.

Fitting configurations include 45 degree elbow configuration, 90 degree elbow configuration, Flange Fitting Configuration, OLET variations involving rigid body, elastomeric body or combining both, T-Fittings where the purge chamber portion has threads, and require to be threaded into the body, depending upon which one of the three butt weld on the “T-fitting” are being welded, and additional fitting configurations and geometries. Further Variations include Purge Chamber portion having a threaded end which must be threaded into the adjoining body, Purge Chamber utilizing quick-connect fittings that are tapped and threaded into the body, Purge Chamber utilizing barbs connect fittings that are tapped and threaded into the body, Purge Chamber utilizing barbs fittings that are molded into the body, and Purge Chamber trailing shield variation.

This chamber design is adaptable to follow the specific curvature of both external (outside diameter) and internal (inside diameter) surfaces of pipes or vessels, thus enabling effective shielding for external welds as well as internal back-welding operations or localized internal purging applications within vessels. In the physical embodiment of FIGS. 1-25, the purge chamber focuses on welding straight pipe sections only. To effectively accommodate more complex joint geometries such as elbows, tees, flanges, or specialized fittings and variations of body, the current purge chamber must undergo explicit redesign and fabrication, tailored to the precise shape and dimensional profiles of each fitting. This process requires generating detailed CAD designs and creating new structural configurations specifically matched to the contours of each individual joint geometry. When adapted appropriately, the chamber retains its fundamental functionality and its critical inert gas shielding capabilities.

The purge chamber's scalable design accommodates pipe diameters ranging from less than 1 inch for precision welding tasks, training purposes, or demonstrations to diameters of 12 inches or greater, suitable for substantial industrial applications. Additionally, smaller-scale ‘miniature’ versions may be produced for demonstration or promotional purposes, while larger-diameter chambers can be fabricated in modular segments to facilitate practical handling, convenient assembly, and scalable field deployment.

When complete 360-degree shielding is impractical due to factors such as large pipe or vessel diameters, constraints in fabrication or manufacturing, limited field access, or situations where only a small repair area requires protection, the purge chamber can be effectively used in modular, partial-coverage configurations. These modular chamber segments can be custom-manufactured to cover specific arc lengths, such as 60°, 90°, 120°, 180°, or other specialized angles, providing flexible adaptation to diverse pipe and vessel geometries. See FIG. 38. These bodies can be minimized in size, as well as made of a rigid material, elastomeric material or combination of the two, as shown in FIG. 38. Each segment incorporates an integrated inert gas inlet, diffuser system, perimeter sealing gaskets, and a fully enclosed back-wall, making each segment self-contained and independently operational.

Each independent modular segment can function as a standalone unit, eliminating reliance on additional segments or the need for a complete 360-degree enclosure, ensuring reliable inert gas shielding even when a full chamber setup is impractical or unnecessary. This modular, partial-coverage approach is particularly advantageous in scenarios involving rapid field repairs, orbital welding procedures, or in-service modifications where operational flexibility and ease-of-use are essential. Operators can readily clamp, strap, wrap or manually position these modular segments directly over the weld zone, repositioning them easily along the pipe or vessel as welding operations progress, thus ensuring continuous and precise inert-gas protection.

By integrating a field-swappable, modular high-temperature architecture featuring interchangeable segments of refractory ceramics, high-performance thermoplastics (PEI, PPS, PEEK), fiber-reinforced composites, metallic bodies (e.g., 316L stainless steel, Inconel 625), or elastomeric flex variants alongside innovative snap-in gaskets, inflatable sealing bladders, hybrid rigid-elastomer assemblies, and optional embedded thermal-management and real-time monitoring modules, the enhanced purge chamber delivers rapid, tool-free reconfiguration and consistently pure inert atmospheres, optimized metallurgical integrity, and streamlined operational performance when welding reactive or corrosion-sensitive alloys such as titanium, zirconium, and aluminum in the most demanding aerospace, nuclear, chemical-processing, semiconductor, and advanced-manufacturing environments.

### Material and Geometric Limitations:

The purge chamber system has evolved beyond its original split-shell configuration of FIGS. 1-25 to address significant limitations in geometry accommodation and material performance. The original utility patent's purge chamber was engineered to clamp around straight pipe sections only, creating challenges when welds needed to be performed on elbows, tees, flanges, saddle joints, inside diameter of vessels, or other non-linear fittings. Furthermore, the initial design relied on heat-resistant polymers and silicone gaskets that, while functional at moderate temperatures, tended to embrittle or soften after repeated thermal cycling, risking compromised seal integrity and structural performance under extreme welding conditions. These limitations necessitated a comprehensive redesign incorporating advanced materials and modular configurations to meet the demanding requirements of modern reactive metal welding applications.

Advanced Materials and Modularity: To overcome these material and geometric constraints, the enhanced purge chamber apparatus introduces a much broader palette of materials ranging from refractory ceramics and high-performance thermoplastics (PEI, PPS, PEEK) to fiber-reinforced composites and even fully metallic bodies such as 316L stainless steel and Inconel 625 that can withstand continuous service above 500° C. without loss of performance. The system now incorporates modular high-temperature adaptability through hot-swap modules that provide robust, load-bearing support and thermal resilience, while elastomeric flex variants feature fully flexible body and purge chamber molded from high-temperature silicones, Viton® FKM, EPDM, perfluoroelastomers (Kalrez®), or PTFE-coated compounds that conform to cables, gussets, OLETs, and irregular contours while sealing up to approximately 320° C. and rolling up for compact storage. These hybrid rigid-elastomer assemblies combine structural strength with gas-tight sealing for continuous service well above 320° C., offering outstanding chemical inertness, minimal off-gassing, and superior UV/ozone resistance.

Custom-Arc Segments: As shown in FIG. 38, the apparatus now offers unprecedented geometric flexibility through custom-arc segment configurations that expand beyond the traditional design approach of combining two 180° bodies to form a complete 360° circumference purge chamber. Instead, the system can be configured as interchangeable arc segments in various configurations, including 60°, 90°, 120°, and 180° segments, each incorporating its own inlet system, diffuser mechanism, and gasket material to operate as an independent purge chamber apparatus. These segments do not require completion of a full 360° configuration to provide effective protection, unlike the traditional purge chamber apparatus, and allow for an extensive assortment of variations, including different arc segment configurations and miniaturized versions to accommodate diverse application requirements. This segmental approach enables targeted purging of specific weld zones while reducing inert gas consumption and providing unprecedented access for complex welding operations.

Internal-Radius Variants: A particularly innovative advancement is the introduction of internal-radius variants that represent a fundamental departure from the original split-shell chamber design that sealed only around the outside diameter of pipe sections. A preferred embodiment of this variant is shown in FIGS. 34A-34J. The internal-radius variant is specifically engineered to follow the inside contour of piping and pressure vessels, enabling true back-welding and targeted purge operations within enclosed bores. This configuration provides precision back-welding capabilities by sealing on the inside diameter, allowing welders to perform back welds or repairs from within the pipe or vessel, while offering localized purge control that isolates and purges only the immediate weld zone rather than filling the entire pipe or vessel bore like bladder bags, foam pigs, or water-soluble dams. The internal chamber can achieve oxygen levels below 25 parts per million in minutes rather than hours, and because no tapes, gels, or soluble materials contact the weld surface, there is zero risk of adhesive or particulate contamination entering the joint, ensuring completely residue-free and clean welding operations.

Inflatable Sealing Members: The enhanced system also incorporates inflatable sealing members comprising elastomeric bladders or dual-balloon cuffs that are pressurized with inert gas to adapt to non-cylindrical geometries and complex surfaces, achieving superior seals at service temperatures up to approximately 300° C. An embodiment of this version is shown in FIGS. 33A-F. These inflatable assemblies may be constructed from high-temperature silicones, fluoroelastomers, or woven glass fabrics coated with heat-resistant polymers, with the sealing element comprising an inflatable bladder or expandable cuff that, when expanded, defines the gas-tight seal. For internal purge-chamber apparatus applications, the inflatable/expandable body variant allows complete enclosure or “wrapping” of a full 360 degrees on the inside diameter of the pipe or vessel, enabling the inflatable member to be pressurized, filling the expandable body and creating an exceptionally tight seal. Additionally, specialized phase-change materials (PCM) can be strategically integrated into the chamber structure to absorb and release thermal energy, ensuring precise control over inter-pass temperatures and enhancing overall welding consistency. Suitably, the inflatable bladders or dual-balloon cuffs, pressurized with inert gas” and the ability to completely enclose- or ‘wrap’—a full 360 degrees on the inside diameter of the pipe or vessel.

Alternative Latching Mechanisms: Recognizing the complexity and maintenance challenges associated with the original recessed mechanical latches that increased part count, manufacturing complexity, and created additional moving parts, the improved design implements simpler, more reliable sealing methods. The rigid-body variants eliminate recessed mechanical latches entirely by using a stainless-steel band clamp that wraps around the purge chamber body and tightens to form an effective seal, while elastomeric-flex variants feature a chamber outer shell made from flexible elastomeric material that simply wraps around the part and folds back onto itself, creating a continuous, gas-tight seal without requiring any hardware whatsoever. Hybrid rigid-elastomer assemblies combine a rigid frame with the same wrap-around elastomeric material, allowing operators to “fold back” the elastomer onto itself to seal while gaining added structural support from the rigid sections. These approaches eliminate complex moving latches, reduce part count, and enable faster, tool-free setup and maintenance in field conditions, significantly improving operational efficiency and reliability.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, 5 block diagrams and their accompanying description should not be construed as mandating a particular architecture or configuration.

All original claims submitted with this specification are incorporated by reference in their entirety as if fully set forth herein.

I claim:

1. A method for creating an inert welding environment, comprising:
positioning modular split-shell assemblies (1000) around a weld joint (3100) of a tubular workpiece (3000), wherein each split-shell assembly includes concentric reducers (1000) with a receptacle (1101) and hood (1102);
securing the split-shell assemblies (1000) via a recessed latch system (1110) to compress a silicone gasket (1120) against the workpiece (3000), forming an airtight seal;
distributing inert gas through a gas distribution network (1200) comprising eight ¼″ hoses (1210) connected to a manifold (1220), wherein the gas flows sequentially through stainless steel wool (1130), fine mesh (1140), and perforated sheet (1150) diffusers to achieve laminar flow;
sealing an access gap between the split-shell assemblies (1000) with heat-resistant tape (1300) during non-welding intervals; and
regulating internal chamber pressure between 0.5-1.5 psi via adjustable vent holes (1230).

2. A method for contamination-free welding, comprising:
establishing a purge chamber (2000) around a weld joint (3100) by clamping split-shell assemblies (1000) onto a workpiece (3000) and securing them via recessed latches (1110); initiating a gas flow at 25-35 CFH through a gas distribution network (1200) to displace atmospheric oxygen below 25 ppm; and,
welding through an access gap between the split-shell assemblies (1000).

3. A modular purge chamber assembly for welding reactive metals, comprising:
two split concentric reducers (1000) that are each fabricated from heat-resistant polymer, including a receptacle (1101) and hood (1102);
a recessed latch system (1110) positioned on opposing sides of at least one of the two reducers (1000) to compress a silicone gasket (1120) against a workpiece (3000);
a gas distribution network (1200) integrated into the hood (1102), of said at least one of the two reducers (1000) where the gas distribution network comprises at least one hose (1210) connected to a manifold (1220) and layered diffusers (1130, 1140, 1150) disposed within the hood (1102) of said at least one of the two reducers (1000);
Wherein the two reducers (1000) are positioned with the hoods (1002) facing each other such that an access gap exists between the hoods (1102) the two assemblies (1000), permitting welding torch access to a weld joint (3100) on the workpiece disposed within the hoods (1002).

4. The method of claim 1, wherein the concentric reducers (1000) include a beveled guide rim (1103) along the hood (1102) to align welding torches during operation.

5. The method of claim 4, further comprising the step of setting a welding torch against the beveled guide rim (1103) and sliding the welding torch along at least a portion of the beveled guide rim (1103).

6. The method of claim 5, further comprising stabilizing the split-shell assemblies (1000) to accommodate oblique or horizontal workpiece orientations.

7. The method of claim 5, wherein the silicone gasket (1120) is pre-molded with a corrugated profile to conform to +10% variations in workpiece diameter.

8. The method of claim 2, wherein the concentric reducers (1000) include a beveled guide rim (1103) along the hood (1102) to align welding torches during operation and further comprising the step of setting a welding torch against the beveled guide rim (1103).

9. The method of claim 8 further comprising the step of sliding the welding torch along at least a portion of the beveled guide rim (1103).

10. The method of claim 9, further comprising stabilizing the split-shell assemblies (1000) to accommodate oblique or horizontal workpiece orientations.

11. The method of claim 9, wherein the silicone gasket (1120) is pre-molded with a corrugated profile to conform to +10% variations in workpiece diameter.

12. The method of claim 11 further comprising the step of compressing the silicon gasket (1120) against a surface of the workpiece.

13. The method of claim 2 further comprising the steps of maintaining inert gas coverage during post-weld cooling until the workpiece (3000) reaches temperatures below 400° C.; and
removing the purge chamber (2000) after weld solidification.

14. The assembly of claim 3, wherein the layered diffusers (1130, 1140, 1150) comprise stainless steel wool (1130), 200-mesh woven screens (1140), and perforated sheets (1150) with 2 mm apertures.

15. The assembly of claim 14, wherein the concentric reducers (1000) include a beveled guide rim (1103) along a rim the hood (1102) of said at least one of the two reducers (1000) to align the welding torch when it set against said rim (1103).

16. The assembly of claim 15 further comprising quick-connect adapters (1230) on the hood (1102) for coupling the hose (1210) to the hood (1102).

17. The assembly of claim 15, wherein quick connect adapters (1230) are positioned to enable gravity-assisted gas venting in vertical orientations.

18. The assembly of claim 3, wherein the silicone gasket (1120) is thermally stable up to 500° C. and includes embedded fiberglass reinforcement.

19. The assembly of claim 15, wherein a thermal tape (1300) is provided around said gap.

20. The assembly of claim 19 where said thermal tape (1300) includes a viewing window (1310).
